(19) United States
(12) Patent Application Publication
(10) Pub. No.: US 2026/0211138 A1
(43) Pub. Date: Jul. 23, 2026

(54) SEISMIC IMAGING FRAMEWORK

(71) Applicant: SCHLUMBERGER TECHNOLOGY CORPORATION, Sugar Land, TX (US)

(72) Inventors: Robin FLETCHER, Crawley (GB); James HOBRO, Cambridge (GB); James RICKETT, Cambridge (GB)

(21) Appl. No.: 19/140,390

(22) PCT Filed: Mar. 8, 2024
(86) PCT No.: PCT/US2024/019056

§ 371 Date: Jun. 18, 2025

Related U.S. Application Data
(60) Provisional application No. 63/451,562, filed on Mar. 11, 2023.

(51) Int. Cl. G01V 1/28; G01V 1/30

(52) U.S. Cl. CPC G01V 1/282; G01V 1/306; G01V 1/307; G01V 2210/614; G01V 2210/6222; G01V 2210/632

(57) ABSTRACT

A method can include receiving a seismic model for a geologic region, where the seismic model includes an acoustic portion that accounts for wavefield kinematics using one or more acoustic velocity parameters and an elastic portion that accounts for wavefield elastic plane-wave reflectivity using one or more elastic vector reflectivity parameters; performing a wavefield simulation using the seismic model; during the wavefield simulation, determining angle dependent wavefield amplitude correction terms, subject to one or more structural dip-based angle criteria, using the elastic portion of the model; during the wavefield simulation, applying the angle dependent wavefield amplitude correction terms to wavefield amplitudes of the wavefield simulation to enhance seismic energy-based accuracy of the wavefield simulation; and generating a simulated wavefield as an output of the wavefield simulation.

### RELATED APPLICATION

This application claims priority to and the benefit of a U.S. Provisional Application having Ser. No. 63/451,562, filed 11 Mar. 2023, which is incorporated by reference herein in its entirety.

### BACKGROUND

Reflection seismology finds use in geophysics to estimate properties of subsurface formations. Reflection seismology may provide seismic data representing waves of elastic energy as transmitted by P-waves and S-waves, in a frequency range of approximately 1 Hz to approximately 100 Hz. In various instances, seismic data can also represent refractions and/or diving waves. Seismic data may be processed and interpreted to understand better composition, fluid content, extent and geometry of subsurface rocks. For example, a full-waveform inversion (FWI) may be implemented as part of a seismic data workflow for building a model of a subsurface environment where information from reflections, refractions and/or diving waves may be considered.

### SUMMARY

A method can include receiving a seismic model for a geologic region, where the seismic model includes an acoustic portion that accounts for wavefield kinematics using one or more acoustic velocity parameters and an elastic portion that accounts for wavefield elastic plane-wave reflectivity using one or more elastic vector reflectivity parameters; performing a wavefield simulation using the seismic model; during the wavefield simulation, determining angle dependent wavefield amplitude correction terms, subject to one or more structural dip-based angle criteria, using the elastic portion of the model; during the wavefield simulation, applying the angle dependent wavefield amplitude correction terms to wavefield amplitudes of the wavefield simulation to enhance seismic energy-based accuracy of the wavefield simulation; and generating a simulated wavefield as an output of the wavefield simulation. A system can include a processor; memory operatively coupled to the processor; and processor-executable instructions stored in the memory to instruct the system to: receive a seismic model for a geologic region, where the seismic model includes an acoustic portion that accounts for wavefield kinematics using one or more acoustic velocity parameters and an elastic portion that accounts for wavefield elastic plane-wave reflectivity using one or more elastic vector reflectivity parameters; perform a wavefield simulation using the seismic model; during the wavefield simulation, determine angle dependent wavefield amplitude correction terms, subject to one or more structural dip-based angle criteria, using the elastic portion of the model; during the wavefield simulation, apply the angle dependent wavefield amplitude correction terms to wavefield amplitudes of the wavefield simulation to enhance seismic energy-based accuracy of the wavefield simulation; and generate a simulated wavefield as an output of the wavefield simulation. One or more computer-readable storage media can include computer-executable instructions executable to instruct a computing system to: receive a seismic model for a geologic region, where the seismic model includes an acoustic portion that accounts for wavefield kinematics using one or more acoustic velocity parameters and an elastic portion that accounts for wavefield elastic plane-wave reflectivity using one or more elastic vector reflectivity parameters; perform a wavefield simulation using the seismic model; during the wavefield simulation, determine angle dependent wavefield amplitude correction terms, subject to one or more structural dip-based angle criteria, using the elastic portion of the model; during the wavefield simulation, apply the angle dependent wavefield amplitude correction terms to wavefield amplitudes of the wavefield simulation to enhance seismic energy-based accuracy of the wavefield simulation; and generate a simulated wavefield as an output of the wavefield simulation. Various other examples of methods, systems, devices, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment;

FIG. 2 illustrates examples of survey techniques;

FIG. 3 illustrates examples of survey techniques;

FIG. 4 illustrates examples of survey techniques;

FIG. 5 illustrates an example of forward modeling and an example of inversion;

FIG. 6 illustrates an example of a full-waveform inversion method;

FIG. 7 illustrates an example of a method and an example of a computing system;

FIG. 8 illustrates an example of a model;

FIG. 9 illustrates examples of images;

FIG. 10 illustrates examples of computational results;

FIG. 11 illustrates examples of images;

FIG. 12 illustrates examples of images;

FIG. 13 illustrates examples of images;

FIG. 14 illustrates examples of images;

FIG. 15 illustrates examples of plots of model parameters;

FIG. 16 illustrates an example of an image;

FIG. 17 illustrates examples of images;

FIG. 18 illustrates an example of a computational framework; and

FIG. 19 illustrates components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics to estimate properties of subsurface formations. Reflection seismology can provide seismic data representing waves of elastic energy, as transmitted by P-waves and S-waves, in a frequency range of approximately 1 Hz to approximately 100 Hz or optionally less than 1 Hz and/or optionally more than 100 Hz. Seismic data may be processed and interpreted to understand better composition, fluid content, extent and geometry of subsurface rocks.

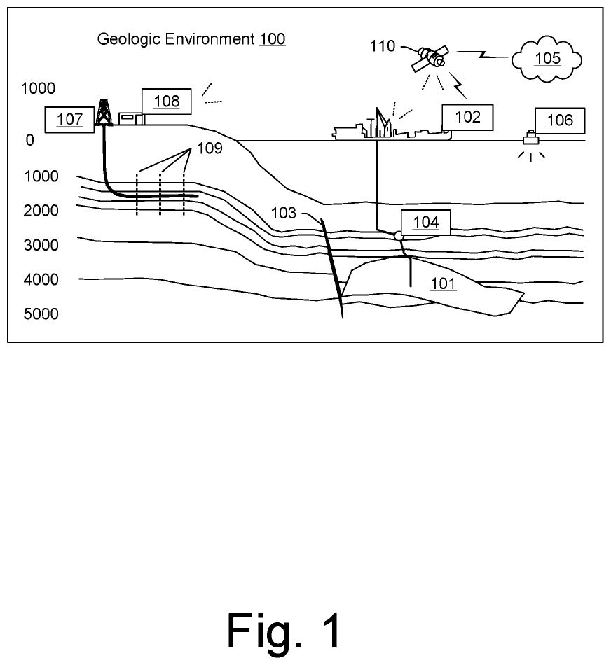

FIG. 1 shows a geologic environment 100 (an environment that includes a sedimentary basin, a reservoir 101, a fault 103, one or more fractures 109, etc.) and an example of an acquisition technique 140 to acquire seismic data (see data 160). A system may process data acquired by the technique 140 to allow for direct or indirect management of sensing, drilling, injecting, extracting, etc., with respect to the geologic environment 100. In turn, further information about the geologic environment 100 may become available as feedback (optionally as input to the system). An operation may pertain to a reservoir that exists in the geologic environment 100 such as the reservoir 101. A technique may provide information (as an output) that specifies one or more location coordinates of a feature in a geologic environment, one or more characteristics of a feature in a geologic environment, etc.

The geologic environment 100 may be referred to as a formation or may be described as including one or more formations. A formation may be a unit of lithostratigraphy such as a body of rock that is sufficiently distinctive and continuous.

A system may be implemented to process seismic data, optionally in combination with other data. Processing of data may include generating one or more seismic attributes, rendering information to a display or displays, etc. A process or workflow may include interpretation, which may be performed by an operator that examines renderings of information (to one or more displays, etc.) and that identifies structure or other features within such renderings. Interpretation may be or include analyses of data with a goal to generate one or more models and/or predictions (about properties and/or structures of a subsurface region).

A system may include features of a framework such as the PETREL seismic to simulation software framework (Schlumberger Limited, Houston, Texas). Such a framework can receive seismic data and other data and allow for interpreting data to determine structures that can be utilized in building a simulation model.

A system may include add-ons or plug-ins that operate according to specifications of a framework environment. As an example, a framework may be implemented within or in a manner operatively coupled to the DELFI cognitive exploration and production (E&P) environment (Schlumberger, Houston, Texas), which is a secure, cognitive, cloud-based collaborative environment that integrates data and workflows with digital technologies, such as artificial intelligence and machine learning. As an example, such an environment can provide for operations that involve one or more frameworks.

Seismic data may be processed using a framework such as the OMEGA framework (Schlumberger Limited, Houston, TX). The OMEGA framework provides features that can be implemented for processing of seismic data through prestack seismic interpretation and seismic inversion.

A framework for processing data may include features for 2D line and 3D seismic surveys. Modules for processing seismic data may include features for prestack seismic interpretation (PSI), optionally pluggable into a framework such as the DELFI framework environment.

In FIG. 1, the geologic environment 100 includes an offshore portion and an on-shore portion. A geologic environment may be or include one or more of an offshore geologic environment, a seabed geologic environment, an ocean bed geologic environment, etc.

The geologic environment 100 may be outfitted with one or more of a variety of sensors, detectors, actuators, etc. Equipment 102 may include communication circuitry that receives and that transmits information with respect to one or more networks 105. Such information may include information associated with downhole equipment 104, which may be equipment to acquire information, to assist with resource recovery, etc. Other equipment 106 may be located remote from a well site and include sensing, detecting, emitting or other circuitry and/or be located on a seabed. Such equipment may include storage and communication circuitry that stores and that communicates data, instructions, etc. One or more satellites may be provided for purposes of communications, data acquisition, etc. FIG. 1 shows a satellite 110 in communication with the network 105 that may be configured for communications, noting that the satellite may additionally or alternatively include circuitry for imagery (spatial, spectral, temporal, radiometric, etc.).

FIG. 1 also shows the geologic environment 100 as optionally including equipment 107 and 108 associated with a well that includes a substantially horizontal portion that may intersect with one or more of the one or more fractures 109; consider a well in a shale formation that may include natural fractures, artificial fractures (hydraulic fractures) or a combination of natural and artificial fractures. The equipment 107 and/or 108 may include components, a system, systems, etc. for fracturing, seismic sensing, analysis of seismic data, assessment of one or more fractures, etc.

A system may be used to perform one or more workflows. A workflow may be a process that includes a number of worksteps. A workstep may operate on data to create new data, to update existing data, etc. A system may operate on one or more inputs and create one or more results based on one or more algorithms. A workflow may be a workflow implementable in the PETREL software that operates on seismic data, seismic attribute(s), etc. A workflow may be a process implementable in the DELFI environment, etc. A workflow may include one or more worksteps that access a plug-in (external executable code, etc.). A workflow may include rendering information to a display (a display device). A workflow may include receiving instructions to interact with rendered information to process information and optionally render processed information. A workflow may include transmitting information that may control, adjust, initiate, etc. one or more operations of equipment associated with a geologic environment (in the environment, above the environment, etc.).

As an example, an acquisition technique can be utilized to perform a seismic survey. A seismic survey can acquire various types of information, which can include various types of waves (e.g., P, SV, SH, etc.). A P-wave can be an elastic body wave or sound wave in which particles oscillate in the direction the wave propagates. P-waves incident on an interface (at other than normal incidence, etc.) may produce reflected and transmitted S-waves (“converted” waves). An S-wave or shear wave may be an elastic body wave in which particles oscillate perpendicular to the direction in which the wave propagates. S-waves may be generated by a seismic energy source (other than an air gun). S-waves may be converted to P-waves. S-waves tend to travel more slowly than P-waves and do not travel through fluids that do not support shear. Recording of S-waves involves use of one or more receivers operatively coupled to earth (capable of receiving shear forces with respect to time). Interpretation of S-waves may allow for determination of rock properties such as fracture density and orientation, Poisson's ratio and rock type by crossplotting P-wave and S-wave velocities, and/or by other techniques. Parameters that may characterize anisotropy of media (seismic anisotropy) include the Thomsen parameters ϑ, δ and γ.

Seismic data may be acquired for a region in the form of traces. For example, a technique can utilize a source for emitting energy where portions of such energy (directly and/or reflected) may be received via one or more sensors (e.g., receivers). Energy received may be discretized by an analog-to-digital converter that operates at a sampling rate. Acquisition equipment may convert energy signals sensed by a sensor to digital samples at a rate of one sample per approximately 4 ms. Given a speed of sound in a medium or media, a sample rate may be converted to an approximate distance. The speed of sound in rock may be of the order of around 5 km per second. Thus, a sample time spacing of approximately 4 ms would correspond to a sample “depth” spacing of about 10 meters (assuming a path length from source to boundary and boundary to sensor). A trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing scenario is divided by two (to account for reflection), for a vertically aligned source and sensor, the deepest boundary depth may be estimated to be about 10 km (assuming a speed of sound of about 5 km per second).

As mentioned, seismic data may be acquired and analyzed to understand better subsurface structure of a geologic environment. Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less than 1 Hz and/or optionally more than 100 Hz). Seismic data may be processed and interpreted, for example, to understand better composition, fluid content, extent and geometry of subsurface rocks.

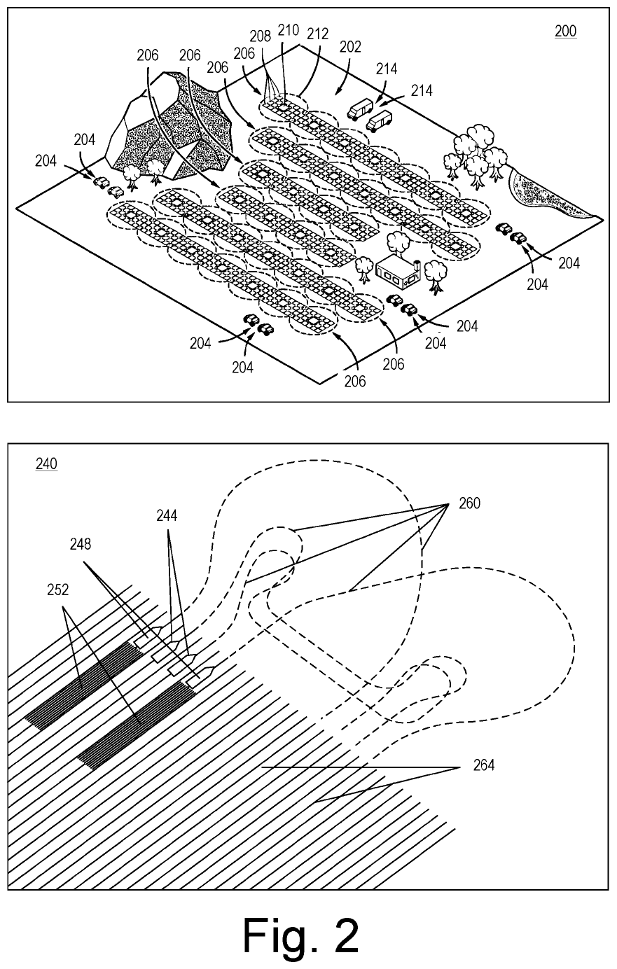

FIG. 2 shows an example of a simplified schematic view of a land seismic data acquisition system 200 and an example of a simplified schematic view of a marine seismic data acquisition system 240.

As shown with respect to the system 200, an area 202 to be surveyed may or may not have physical impediments to direct wireless communication between a recording station 214 (which may be a recording truck) and a vibrator 204. A plurality of vibrators 204 may be employed, as well as a plurality of sensor unit grids 206, each of which may have a plurality of sensor units 208.

As illustrated in FIG. 2 with respect to the system 200, approximately 24 to about 28 sensor units 208 may be placed in a vicinity (a region) around a base station 210. The number of sensor units 208 associated with each base station 210 may vary from survey to survey. Circles 212 indicate an approximate range of reception for each base station 210.

In the system 200 of FIG. 2, the plurality of sensor units 208 may be employed in acquiring and/or monitoring land-seismic sensor data for the area 202 and transmitting the data to the one or more base stations 210. Communications between the vibrators 204, the base stations 210, the recording station 214, and the seismic sensors 208 may be wireless (at least in part via air for a land-based system; or optionally at least in part via water for a sea-based system).

In the system 240 of FIG. 2, one or more source vessels 240 may be utilized with one or more streamer vessels 248 or a vessel or vessels may tow both a source or sources and a streamer or streamers 252. In the example of FIG. 2, the vessels 244 and 248 (e.g., or just the vessels 248 if they include sources) may follow predefined routes (e.g., paths) for an acquisition geometry that includes inline and crossline dimensions. As shown, routes 260 can be for maneuvering the vessels to positions 264 as part of the survey. As an example, a marine seismic survey may call for acquiring seismic data during a turn (e.g., during one or more of the routes 260).

The example systems 200 and 240 of FIG. 2 demonstrate how surveys may be performed according to an acquisition geometry that includes dimensions such as inline and crossline dimensions, which may be defined as x and y dimensions in a plane or surface where another dimension, z, is a depth dimension. As explained, time can be a proxy for depth, depending on various factors, which can include knowing how many reflections may have occurred as a single reflection may mean that depth of a reflector can be approximated using one-half of a two-way traveltime, some indication of the speed of sound in the medium and positions of the receiver and source (e.g., corresponding to the two-way traveltime).

Two-way traveltime (TWT) can be defined as the elapsed time for a seismic wave to travel from its source to a given reflector and return to a receiver (e.g., at a surface, etc.). As an example, a minimum two-way traveltime can be defined to be that of a normal-incidence wave with zero offset.

As an example, a seismic survey can include points referred to as common midpoints (CMPs). In multichannel seismic acquisition, a CMP is a point that is halfway between a source and a receiver that is shared by a plurality of source-receiver pairs. In such a survey, various angles may be utilized that may define offsets (e.g., offsets from a CMP, etc.). In a CMP approach, redundancy among source-receiver pairs can enhance quality of seismic data, for example, via stacking of the seismic data. A CMP can be vertically above a common depth point (CDP), or common reflection point (CRP). As an example, seismic data may be presented as a gather, which can be an image of seismic traces that share an acquisition parameter, such as a common midpoint gather (CMP gather or CMG), which contains traces having a common midpoint (CMP). In such an example, a CMG may be presented with respect to a horizontal dimension and a time dimension, which may be a TWT dimension.

As an example, a seismic survey can include points referred to as downward reflection points (DRPs). A DRP is a point where seismic energy is reflected downwardly. For example, where multiple interfaces exist, seismic energy can reflect upwardly from one interface, reach a shallower interface and then reflect downwardly from the shallower interface.

As an example, a seismic survey may be an amplitude variation with offset (AVO) survey. Such a survey can record variation in seismic reflection amplitude with change in distance between position of a source and position of a receiver, which may indicate differences in lithology and fluid content in rocks above and below a reflector.

AVO analysis can allow for determination of one or more characteristics of a subterranean environment (e.g., thickness, porosity, density, velocity, lithology and fluid content of rocks, etc.). As an example, gas-filled sandstone might show increasing amplitude with offset; whereas, a coal might show decreasing amplitude with offset. AVO analysis can be suitable for young, poorly consolidated rocks, such as those in the Gulf of Mexico.

As an example, a method may be applied to seismic data to understand better how structural dip may vary with respect to offset and/or angle as may be associated with emitter-detector (e.g., source-receiver) arrangements of a survey, for example, to estimate how suitable individual offset/angle gathers are for AVO imaging. As explained, a gather may be a collection of seismic traces that share an acquisition parameter, such as a common midpoint (CMP), with other collections of seismic traces. For example, consider an AVO survey that includes a plurality of emitter-detector arrangements (e.g., source-receiver pairs) with corresponding angles defined with respect to a common midpoint (CMP). Given a CMP, acquired survey data may be considered to cover a common subsurface region (e.g., a region that includes the midpoint).

As an example, one or more features in a geologic environment may be characterized in part by dip. As an example, dip may be specified according to a convention where the three-dimensional orientation of a plane may be defined by its dip and strike. Dip can be the angle of slope of a plane from a horizontal plane (e.g., an imaginary plane) measured in a vertical plane in a specific direction. Dip may be defined by magnitude (e.g., also known as angle or amount) and azimuth (e.g., also known as direction). A convention can involve various angles, for example, an angle γ can indicate angle of slope downwards, for example, from an imaginary horizontal plane (e.g., flat upper surface); whereas, azimuth refers to the direction towards which a dipping plane slopes (e.g., which may be given with respect to degrees, compass directions, etc.). Another feature in a convention can be strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (e.g., Dip_{T}). True dip is the dip of a plane measured directly perpendicular to strike (see, e.g., line directed northwardly and labeled “strike” and angle @90) and also the maximum possible value of dip magnitude. Another term is “apparent dip” (e.g., Dip_{A}). Apparent dip may be the dip of a plane as measured in any other direction except in the direction of true dip (e.g., γ_{A} as Dip_{A} for angle α); however, it is possible that the apparent dip is equal to the true dip (e.g., γ as Dip_{A}=Dip for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

The dip of a plane may be seen in a cross-section perpendicular to the strike is true dip (e.g., the surface with γ as Dip_{A}=Dip_{T} for angle α₉₀ with respect to the strike). As an example, dip observed in a cross-section in any other direction is apparent dip (e.g., Dip_{A}). Apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

Various techniques, tools, etc., may be utilized to determine dip. For example, consider a dipmeter tool as a downhole tool that can acquire measurements to obtain structural dips of layers traversed by a borehole. Such a dipmeter may be sensitive to variations in electrical properties of rocks along tracks of a borehole wall where measurements can be presented as curves that can be correlated. As an example, dips can be measured with respect to a borehole (e.g., apparent dips) or with respect to a particular direction, such as, for example, geographic north and the earth's vertical at a given location (e.g., true dips).

A convention may be used with respect to an analysis, an interpretation, an attribute, a model, etc. As an example, various types of features may be described, in part, by dip (e.g., sedimentary bedding, horizons, faults and fractures, cuestas, igneous dikes and sills, metamorphic foliation, etc.).

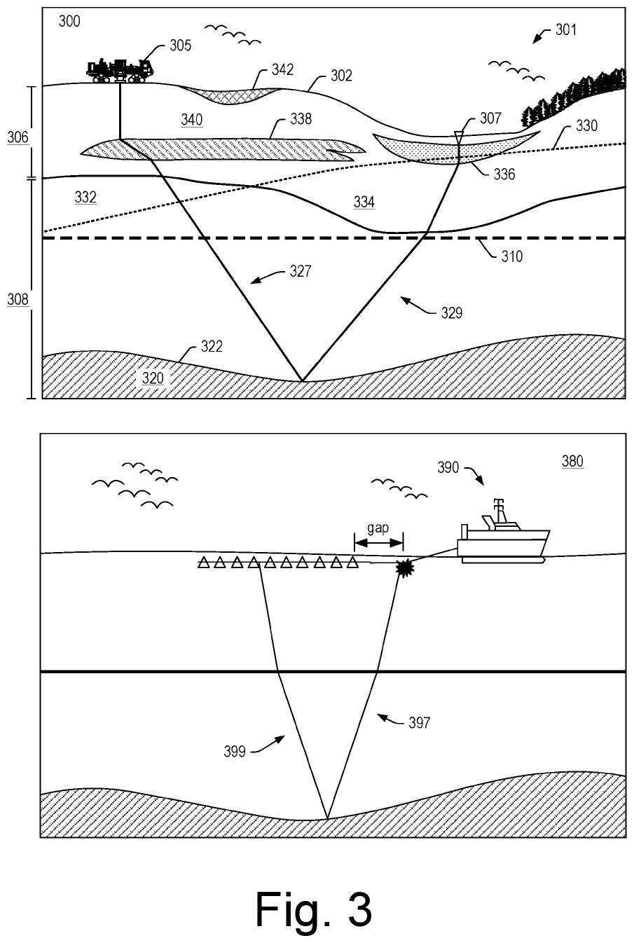

FIG. 3 shows an example of a land system 300 and an example of a marine system 380. The land system 300 is shown in a geologic environment 301 that includes a surface 302, a source 305 at the surface 302, a near-surface zone 306, a receiver 307, a bedrock zone 308 and a datum 310 where the near-surface zone 306 (e.g., near-surface region) may be defined at least in part by the datum 310, which may be a depth or layer or surface at which data above are handled differently than data below. For example, a method can include processing seismic data that aims to “place” the source 305 and the receiver 307 on a datum plane defined by the datum 310 by adjusting (e.g., “correcting”) traveltimes for propagation through the near-surface region (e.g., a shallower subsurface region).

In the example system 300 of FIG. 3, the geologic environment 301 can include various features such as, for example, a layer 320 that defines an interface 322 that can be a reflector, a water table 330, a leached zone 332, a glacial scour 334, a buried river channel 336, a region of material 338 (e.g., ice, evaporates, volcanics, etc.), a high velocity zone 340, and a region of material 342 (e.g., Eolian or peat deposits, etc.).

In FIG. 3, the land system 300 is shown with respect to downgoing rays 327 (e.g., downgoing seismic energy) and upgoing rays 329 (e.g., upgoing seismic energy). As illustrated the rays 327 and 329 pass through various types of materials and/or reflect off of various types of materials.

Various types of seismic surveys can contend with surface unevenness and/or near-surface heterogeneity. For example, a shallow subsurface can include large and abrupt vertical and horizontal variations that may be, for example, caused by differences in lithology, compaction cementation, weather, etc. Such variations can generate delays or advances in arrival times of seismic waves passing through them relative to waves that do not. By accounting for such time differences, a seismic image may be of enhanced resolution with a reduction in false structural anomalies at depth, a reduction in mis-ties between intersecting lines, a reduction in artificial events created from noise, etc.

As an example, a method can include adjusting for such time differences by applying a static, or constant, time shift to a seismic trace where, for example, applying a static aims to place a source and receiver at a constant datum plane below a near-surface zone. As an example, an amount by which a trace is adjusted can depend on one or more factors (e.g., thickness, velocity of near-surface anomalies, etc.).

In FIG. 3, the datum 310 is shown, for example, as a plane, below which strata may be of particular interest in a seismic imaging workflow. In a three-dimensional model of a geologic environment, a near surface region may be defined, for example, at least in part with respect to a datum. As an example, a velocity model may be a multidimensional model that models at least a portion of a geologic environment.

In the example of FIG. 3, the source 305 can be a seismic energy source such as a vibrator. As an example, a vibrator may be a mechanical source that delivers vibratory seismic energy to the Earth for acquisition of seismic data. As an example, a vibrator may be mounted on a vehicle (e.g., a truck, etc.). As an example, a seismic source or seismic energy source may be one or more types of devices that can generate seismic energy (e.g., an air gun, an explosive charge, a vibrator, etc.).

Vibratory seismic data can be seismic data whose energy source is a vibrator that may use a vibrating plate to generate waves of seismic energy. As an example, the frequency and the duration of emitted energy can be controllable, for example, frequency and/or duration may be varied according to one or more factors (e.g., terrain, type of seismic data desired, etc.).

As an example, a vibrator may emit a linear sweep of a duration that is of the order of seconds (e.g., at least seven seconds, etc.), for example, beginning with high frequencies and decreasing with time (downsweeping) or going from low to high frequency (upsweeping). As an example, frequency may be changed (e.g., varied) in a nonlinear manner (e.g., certain frequencies are emitted longer than others, etc.). In various vibrator scenarios, resulting source wavelet can be one that is not impulsive. As an example, parameters of a vibrator sweep can include start frequency, stop frequency, sweep rate and sweep length.

As an example, a vibrator may be employed in land acquisition surveys for areas where explosive sources may be contraindicated (e.g., via regulations, etc.). As an example, more than one vibrator can be used simultaneously (e.g., in an effort to improve data quality, etc.).

As an example, a receiver may be a may be a UNIQ sensor unit (Schlumberger Limited, Houston, Texas). As an example, a sensor unit can include a geophone, which may be configured to detect motion in a single direction. As an example, a geophone may be configured to detect motion in a vertical direction. As an example, three mutually orthogonal geophones may be used in combination to collect so-called 3C seismic data. As an example, a sensor unit that can acquire 3C seismic data may allow for determination of type of wave and its direction of propagation. As an example, a sensor assembly or sensor unit may include circuitry that can output samples at intervals of 1 ms, 2 ms, 4 ms, etc. As an example, an assembly or sensor unit can include an analog to digital converter (ADC) such as, for example, a 24-bit sigma-delta ADC (e.g., as part of a geophone or operatively coupled to one or more geophones). As an example, a sensor assembly or sensor unit can include synchronization circuitry such as, for example, GPS synchronization circuitry with an accuracy of about plus or minus 12.5 microseconds. As an example, an assembly or sensor unit can include circuitry for sensing of real-time and optionally continuous tilt, temperature, humidity, leakage, etc. As an example, an assembly or sensor unit can include calibration circuitry, which may be self-calibration circuitry.

In FIG. 3, the system 380 includes equipment 390, which can be a vessel that tows one or more sources and one or more streamers (e.g., with receivers). In the system 380, a source of the equipment 390 can emit energy at a location and a receiver of the equipment 390 can receive energy at a location. The emitted energy can be at least in part along a path of the downgoing energy 397 and the received energy can be at least in part along a path of the upgoing energy 399.

In various systems, for one or more reasons, a gap in coverage may exist. For example, in the system 380 a gap is identified and labeled where the gap may be defined as a distance between a seismic source and a seismic receiver. In such an example, the distance may be considered a practical or a safe distance for locating a seismic receiver from a seismic source. If a seismic receiver is too close to a seismic source, the seismic receiver may experience a rather large shock wave and/or may otherwise experience energy that may be quite high and raise concerns with calibration, dynamic range, etc.

In the examples of FIG. 3, the paths are illustrated as single reflection paths for sake of simplicity. In the environments illustrated, additional interactions, reflections can be expected. For example, ghosts may be present. A ghost can be defined as a short-path multiple, or a spurious reflection that occurs when seismic energy initially reverberates upward from a shallow subsurface and then is reflected downward, such as at the base of weathering or between sources and receivers and the sea surface. As an example, the equipment 390 can include a streamer that is configured to position receivers a distance below an air-water interface such that ghosts can be generated where upgoing energy impacts the air-water interface and then reflects downward to the receivers. In such an example, a process may be applied that aims to “deghost” seismic data. Deghosting can be applied to marine seismic survey data where such a process aims to attenuate signals that are downgoing from an air-water interface (i.e., sea surface interface). As mentioned, one or more other techniques, technologies, etc., may be utilized for seismic surveying (e.g., ocean bottom cables, ocean bottom nodes, etc.).

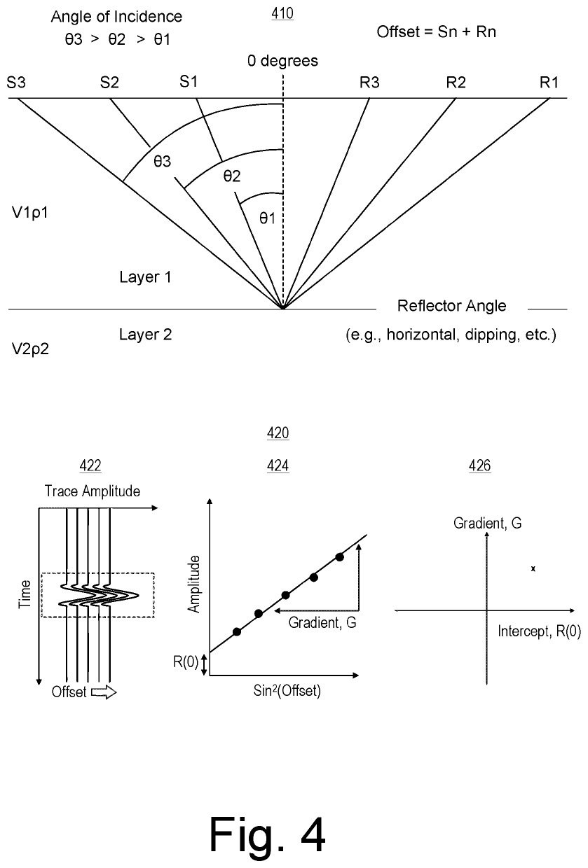

FIG. 4 shows an example of a seismic survey that implements amplitude versus offset (AVO) with respect to a source and receiver diagram 410 and a method 420. AVO finds use in detecting hydrocarbons and reducing drilling risk. AVO can detect hydrocarbons because AVO shows the variation of the amplitude of the offset, which represents the amplitude of the wave energy as it passes through the layer which is influenced by the parameters of the speed and density (e.g., Vn and ρn), so that the density of the layer can be analyzed by analyzing the reflection coefficient. AVO means that amplitude change with offset caused by lithology of fluid. AVO is also known as AVA (amplitude variation with angle) because this phenomenon is based on the relationship between the reflection coefficient and the angle of incidence. But since the angle of incidence affecting the offset and the offset itself can be varied in order to change the angle of incidence, it is commonly known as AVO.

In FIG. 4, the diagram 410 shows sources S1, S2 and S3 and receivers R1, R2 and R3 along with a first layer of material with properties V1 and ρ1 and a second layer of material with properties V2 and ρ2 where an interface is formed between the first later and the second layer, which can be referred to as a reflector (e.g., at least partially reflect energy) and, in acquired data, as an event.

As to the method 420, it can include arranging seismic traces in a plot of amplitude versus time 422 where the traces may be separated due to offset, which can be computed based on source and receiver positions. For example, offset can be computed as a distance from a mid-point (see, e.g., reflection point in the diagram 410) as Sn plus Rn. As shown in a plot 424, amplitude can be plotted versus the sine-squared of offset to discern a gradient G and an intercept R(0). As shown in a plot 426, gradient and intercept can be plotted as a cross-plot to provide a point, as related to the reflector. The method 420 can be referred to as a method of constructing an AVO cross-plot.

Various types of seismic reflection surveys are designed and acquired in such a way that a point in the subsurface can be sampled multiple times, with each sample having a different source and receiver location. The seismic data can then be carefully processed to preserve seismic amplitudes and accurately determine the spatial coordinates of each sample. Such an approach allows a geophysicist to construct a group of traces with a range of offsets that sample a common subsurface location in order to perform AVO analysis. For example, consider a common midpoint gather (CMP gather) where a midpoint is the area of the subsurface that a seismic wave reflects off before returning to the receiver. In an example seismic reflection processing workflow, the average amplitude can be calculated along the time sample, in a process known as stacking. Such an approach can reduce random noise but it may also lose information that could be used for AVO analysis.

A CMP gather can be constructed using traces conditioned so that they reference the same two-way travel time, sorted in order of increasing offset where the amplitude of each trace at a specific time horizon can be extracted. In such an example, considering the 2-term Shuey approximation, the amplitude of each trace can be plotted against sine-squared of its offset such that the relationship becomes linear (see, e.g., the plot 424). Using linear regression, a line of best fit can be calculated that describes how the reflection amplitude varies with offset using just 2 parameters: the intersect, R(0), and the gradient, G. Per the Shuey approximation, the intersect R(0) corresponds to the reflection amplitude at zero-offset and the gradient G describes the behavior at non-normal offset, a value known as the AVO gradient. Plotting R(0) against G for every time sample in every CMP gather produces an AVO cross-plot (see, e.g. the plot 426), which can be interpreted in one or more manners.

In AVO surveys, an AVO anomaly may be expressed as increasing (rising) AVO in a sedimentary section, for example, where a hydrocarbon reservoir is “softer” (e.g., lower acoustic impedance) than surrounding shales. In various instances, amplitude decreases (falls) with offset due to geometrical spreading, attenuation and other factors. An AVO anomaly can also include examples where amplitude with offset falls at a lower rate than the surrounding reflective events.

As mentioned, AVO can be applied for the detection of hydrocarbon reservoirs. Increasing AVO may be present in oil-bearing sediments with at least 10 percent gas saturation, but is especially pronounced in porous, low-density gas-bearing sediments with little to no oil. Some examples are those seen in Middle Tertiary gas sands of the coastal counties of Southeast Texas, turbidite sands such as the Late Tertiary deltaic sediments in the Gulf of Mexico (especially during the 1980s-1990s), West Africa, and other major deltas around the world. AVO can be implemented as a tool to help de-risk exploration targets and to better define extent and composition of hydrocarbon reservoirs.

As an example, various types of sources and/or receivers and seismic survey types may be implemented. As an example, a survey may employ nodes or cables at a water-bed interface where such equipment is positioned on the seabed. As an example, a seismic source vessel may travel a path while, at times, emitting seismic energy from one or more sources. In such an approach, ocean bottom nodes (OBNs) or ocean bottom cables (OBCs) can receive portions of the seismic energy, which can include portions that have travelled through a formation. Analysis of received seismic energy may reveal features of the formation.

As explained, one or more sources may be an air gun or air gun array (a source array) or another type of vibrator (see, e.g., the truck 305 of FIG. 3). For marine surveys, a source can produce a pressure signal that propagates through water into a formation where acoustic and elastic waves are formed through interaction with features (structures, fluids, etc.) in the formation. Acoustic waves can be characterized by pressure changes and a particle displacement in a direction of which the acoustic wave travels. Elastic waves can be characterized by a change in local stress in material and a particle displacement. Acoustic and elastic waves may be referred to as pressure and shear waves, respectively; noting that shear waves may not propagate in water. Collectively, acoustic and elastic waves may be referred to as a seismic wavefield.

Material in a formation may be characterized by one or more physical parameters such as density, compressibility, and porosity. In a geologic environment, energy emitted from one or more sources can be transmitted to a formation; however, elastic waves that reach a seabed will not propagate back into the water. Such elastic waves may be received by sensors of OBNs or OBCs, which can include motion sensors that can measure one or more of displacement, velocity and acceleration. A motion sensor may be a geophone, an accelerometer, etc. As to pressure waves, OBNs and/or OBCs can include pressure wave sensors such as hydrophones.

OBNs and/or OBCs may be utilized to acquire information spatially and temporally such as in a time-lapse seismic survey, which may be a four-dimensional seismic survey (4D seismic survey). A seismic image of a formation may be made for a first survey and a seismic image of the formation may be made for a second survey where the first and second surveys are separated by time (lapse in time). In such an approach, a comparison of the images can infer changes in formation properties that may be tied to production of hydrocarbons, injection of water or gas, etc.

A first survey may be referred to as a baseline survey, while a subsequent survey may be referred to as a monitor survey. To minimize artifacts in differences between seismic images from successive lapses, a monitor survey may aim to replicate a configuration of a corresponding baseline survey.

When seismic traces of a gather come from a single shot and many receivers, they can form a common shot gather; whereas, a single receiver with many shots can form a common receiver gather. A shot gather can be a plot of traces with respect to line distance (e.g., an inline or a crossline series of receivers) with respect to time. Such a plot may be referred to as an image, which includes information about a subsurface region; noting that traces may be processed to generate one or more other types of images of a subsurface region.

Some examples of techniques that can process seismic data include migration and migration inversion, which may be implemented for purposes such as structural determination and subsequent amplitude analysis. In seismic exploration, signal can be defined as a part of a recorded seismic record (e.g., events) that is decipherable and useful for determining subsurface information (e.g., relevant to the location and production of hydrocarbons, etc.). Migration and migration inversion are techniques that can be used to extract subsurface information from seismic reflection data.

As an example, a migration technique can include predicting a coincident source and receiver at depth at a time equal to zero; an approach that may be extended for heterogeneous media and to accommodate two-way propagation in a local sense at points from the source to a target reflector and back from the reflector to the receiver and in a global sense, separately for each of the two legs from the source to the reflector and from the reflector to the receiver. Such an approach for two-way wave propagation migration may provide for quantitative and definitive definition of the roles of primaries and multiples in migration where, for example, migration of primaries can provide subsurface structure and amplitude information.

Various techniques that can be used to predict a wavefield inside a volume from (measured) values of a field on a surface surrounding the volume involve Green's theorem. Green's theorem may be implemented, for example, as part of a process for a finite volume model prediction of the so-called “source and receiver experiment” for two-way waves at depth. As an example, Green's theorem can predict a wavefield at an arbitrary depth z between a shallower depth “a” and a deeper depth “b”.

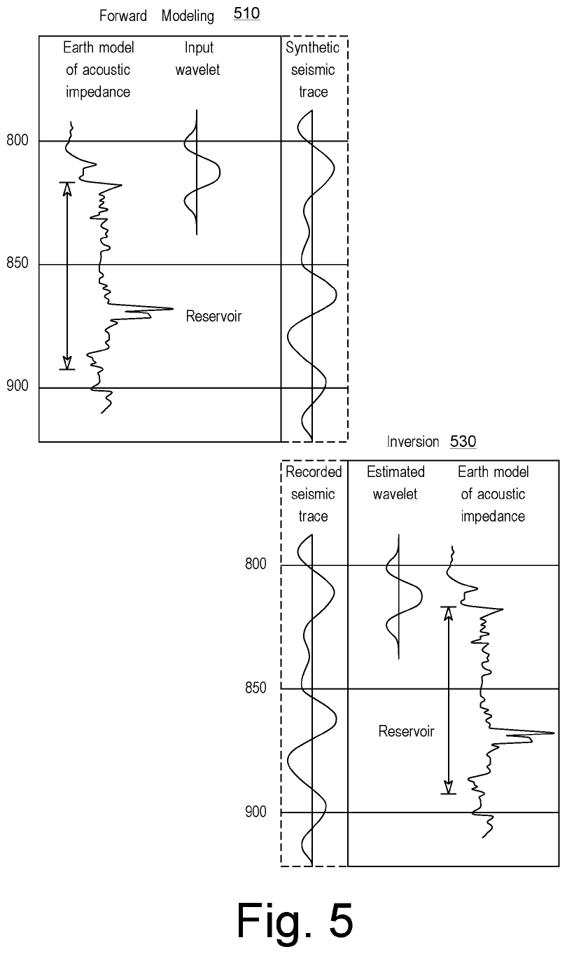

FIG. 5 shows an example of forward modeling 510 and an example of inversion 530 (e.g., an inversion or inverting). As shown, the forward modeling 510 progresses from an earth model of acoustic impedance and an input wavelet to a synthetic seismic trace while the inversion 530 progresses from a recorded seismic trace to an estimated wavelet and an Earth model of acoustic impedance. As an example, forward modeling can take a model of formation properties (e.g., acoustic impedance as may be available from well logs) and combine such information with a seismic wavelength (e.g., a pulse) to output one or more synthetic seismic traces while inversion can commence with a recorded seismic trace, account for effect(s) of an estimated wavelet (e.g., a pulse) to generate values of acoustic impedance for a series of points in time (e.g., depth).

Acoustic impedance is the opposition of a medium to a longitudinal wave motion. Acoustic impedance is a physical property whose change determines reflection coefficients at normal incidence, that is, seismic P-wave velocity multiplied by density. Acoustic impedance characterizes the relationship between the acting sound pressure and the resulting particle velocity.

During the propagation of seismic wave along a ray path, a seismic wave transmits through or reflects at a material boundary and/or converts its vibration mode between P-wave and S-wave. An observed amplitude of a seismic wave depends on an acoustic impedance contrast at a material boundary between an upper medium and a lower medium. Acoustic impedance, Z, can be defined by a multiplication of density, ρ, and seismic velocity, Vp, in each media. Acoustic impedance Z tends to be proportional to Vp for the many sedimentary and crustal rocks (e.g., granite, anorthite, pyrophyllite, and quartzite), except for some ultramafic rocks (e.g., dunite, eclogite, and peridotite) in the mantle.

In various instances, an inversion problem may be ill-posed for one or more reasons. Recorded data can include discrepancies including, for example, missing near offsets (e.g., due to gaps, etc.), and multiple events with other artifacts that contaminate the model of primaries that is inverted for. Artifacts can also be associated with inversion inaccuracies coming from inaccurate physics simulation (e.g., inversion of 3D data using 2D inversion, wavelet estimation errors, etc.).

For various reasons, a seismic survey may have coverage issues. For example, certain subsurface structures may impact “illumination” of one or more regions by seismic energy. In seismology, illumination can refer to an ability for seismic energy to fall on a reflector and thus be available to be reflected. Illumination can depend on source-receiver configuration (e.g., a survey geometry) and velocity distribution such as, for example, irregular velocity contrasts that may bend raypaths differently than adjacent raypaths. Various regions can have complicated velocity variations, for example, consider high-velocity contrast regions and subsalt regions.

A subsalt region can be an exploration and production play type in which prospects exist below salt layers. Prospecting for such regions below salt layers can pose challenges with respect to illumination, which may result in seismic data of poor quality. The Gulf of Mexico includes subsalt-producing fields; noting that subsalt regions also exist in other parts of the world such as, for example, offshore Brazil in the Santos, Campos and Espirito Santo basins.

A region below salt (e.g., a subsalt region) may be referred to as a pre-salt layer. As an example, a region may include a diachronous series of geological formations on a continental shelve of an extensional basin formed after the break-up of Gondwana, which may be characterized by deposition of thick layers of evaporites that can be composed mostly of salt. In various regions, some petroleum generated from sediments in a pre-salt layer may not have migrated upward to post-salt layers above, for example, due to one or more salt domes. Such types of regions exist off the coast of Africa and the coast of Brazil. Total pre-salt hydrocarbon reserves are estimated to be a substantial fraction of the world's hydrocarbon reserves.

Off the coast of Brazil, oil and natural gas reserves lie below an approximately 2,000 m (6,600 ft) thick layer of salt, which in turn is beneath more than 2,000 m (6,600 ft) of post-salt sediments in places, which in turn is under water depths between 2,000 m and 3,000 m (6,600 ft and 9,800 ft) in the South Atlantic. Drilling through rock and salt to extract pre-salt oil and gas can be complicated and costly. As explained, seismic surveying can be challenging in such regions, which can introduce uncertainties in planning, drilling, etc.

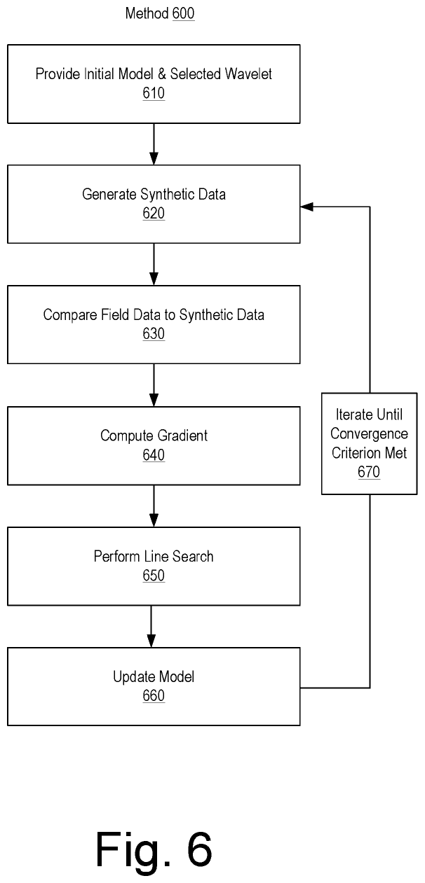

FIG. 6 shows an example of a method 600 that can perform a full waveform inversion (FWI). As shown, the method 600 includes a provision block 610 for providing an initial model and a selected wavelet, a generation block 620 for generating synthetic seismic data using the model and the wavelet, a comparison block 630 for comparing the synthetic seismic data to field seismic data, a computation block 640 for computing a gradient, a performance block 650 for performing a line search and an update block 660 for updating the model to provide an updated model, which may then be used by the generation block 620. As shown, per an iteration block 670, the method 600 can proceed in an iterative manner until one or more convergence criteria are met, which may be based on error between synthetic seismic data and field seismic data. As an example, the method 600 may be implemented by a computational framework such as, for example, the OMEGA framework.

As an example, a model can be a velocity model. A velocity model can be a single dimensional model or a multidimensional model that provides a spatial distribution of velocity in a subsurface environment. For example, consider a model that uses constant-velocity units (layers), through which raypaths obeying Snell's law can be traced. As mentioned, acoustic impedance and velocity are related and, as explained with respect to FIG. 5, a model (e.g., acoustic impedance and/or velocity) can be utilized for forward modeling and inversion (e.g., inverting).

As with various types of inversions, convergence may occur to a local solution rather than to a global solution. For example, a model may be generated that satisfies a local minimum in error where, in actuality, a model can be generated that satisfies a global minimum in error. In other words, the method 600 can get stuck in a sub-optimal solution space such that a generated model is sub-optimal.

As explained with respect to FIG. 5, forward modeling can be used to generate synthetic data and an inversion can generate a model using field data (e.g., actual, real-world data). In the method 600 of FIG. 6, forward modeling is employed to generate the synthetic seismic data, which may be performed using a numerical technique such as the finite difference method (FD method). As to comparing synthetic data to actual data, while the method 600 includes gradient computation and line search, one or more of various techniques may be utilized to update a model for a subsequent iteration.

For various seismic imaging applications, it is useful to decompose an acoustic (or elastic) model into a (possibly smooth) reference model that controls the traveltime of transmitted events, and perturbation component that scatters/reflects the wavefield. In such an approach, primaries can then be modelled by a first-order Born approximation which involves simulating a scattered field, by (i) propagating the source wavefield in the reference model, (ii) scattering once from the perturbation component, and then (iii) a further propagation in the reference model.

As explained, reflection seismology can be performed using various types of equipment. For example, field equipment can include one or more sources and receivers where a source emits energy that is transmitted through various subsurface geologic structures, reflected and acquired by receivers, which may generate digital data (e.g., amplitude data with respect to time). A reflection seismology system can then process the digital data using sophisticated techniques that execute using one or more types of circuitry (e.g., processor-based circuitry, etc.) such that signal can be extracted from noise and/or artefact to generate a digital image of various subsurface geologic structures. For example, through various processing techniques, a reservoir, as a subsurface structure, may be identified as a possible source of hydrocarbons that may be produced through targeted drilling where a digital image and/or a reflection seismology-based model is utilized as a guide. Where a reservoir is more accurately identified (e.g., as to fluid content, extent, surrounding structure, etc.), drilling may be optimized such that a well may be constructed that is robust with sufficient reservoir contact.

One purpose of reflection seismology can be to effectively see that which cannot readily be seen by the human eye. Reflection seismology finds parallels in medical imaging, which may be utilized to generate images and/or models of the human body. For example, 3D computerized tomography can acquire X-ray attenuation data that can be processed to generate a 3D model of one or more structures of the human body (e.g., bones, lungs, heart, colon, etc.). A so-called virtual colonoscopy allows a radiologist to navigate a reconstructed X-ray image-based model of a patient's colon to identify objects (e.g., polyps, tumors, etc.) and boundaries (e.g., diverticulosis as pouches in the digestive tract). However, reflection seismology differs from virtual colonoscopy in that image reconstruction in reflection seismology can depend on a priori knowledge of what is being imaged. Specifically, a model of a subsurface environment can be required, as explained with respect to FIG. 5. For example, an initial model may be provided whereby a reflection seismology system iteratively improves upon the initial model using acquired data. Where an initial model is more accurate, performance of a reflection seismology system may be improved.

The fact that reflection seismology may be performed using a distributed system and over a somewhat extended period of time, compared to medical imaging, does not deter the analogy to medical imaging. Medical imaging is typically performed using equipment that fits into an imaging wing of a hospital where medical imaging equipment may be resident in that imaging wing and readily viewed by a human as a local system, noting that a workstation may be positioned within some meters of an X-ray assembly or a superconducting magnet with various coils for magnetic resonance imaging (MRI). As an expansive subsurface geologic environment cannot fit into an imaging wing of a building, reflection seismology must inherently rely on distributed components. In other words, while these technologies are analogous, a reflection seismology system inherently requires distributed components.

Referring to MRI, as a prevalent type of medical imaging, an MRI image may be reconstructed using an iterative least squares algorithm. In one variant, the iterative least squares algorithm is configured for optimizing either a preexisting or archived coils sensitivity map into the imaging coil sensitivity map during reconstruction of the MRI image. In another variant, the imaging coil sensitivity map is determined wholly through the iterative process, where the MRI image is reconstructed by iteratively maximizing consistency between the MRI data, the MRI image, and an imaging coil sensitivity map. In various instances, an MRI system may use one or more stored coil sensitivity profiles that may be used as a starting point for the reconstruction of the optimized consistent image and coil sensitivities. In such an approach, archived coil sensitivities may be a better starting point. Further, the archived coil sensitivities profile may be retrieved by querying a database on the basis of metadata which enables a selection from coil sensitives that have already appeared to be in consistency with magnetic resonance images.

As explained, FWI is one type of inversion technique that may be employed by a reflection seismology system to generate images and/or a model based on acquired seismic data. As an example, a framework may provide for handling of structural dip of a subsurface geologic environment being imaged. In such an approach, the structural dip may be represented in a model of the subsurface geologic environment; noting that how energy is transmitted and/or reflected can depend on structural dip of a reflector or reflectors in the subsurface geologic environment. Accordingly, structural dip is a characteristic of a subsurface geologic environment that impacts reflection seismology and therefore can be taken into account when generating images and/or a model of the subsurface geologic environment. Where structural dip is appropriately accounted for, image and/or model generation can be improved. For example, consider improvements as to actual performance of a reflection seismology system (e.g., fewer iterations in an FWI process, better convergence, etc.), which may lead to improvements in output (e.g., a more accurate image and/or model).

Dip in a subsurface geologic environment can impact various aspects of reflection seismology. For example, migration may stretch waveforms of dipping reflections, which may, in turn, impact quantitative interpretation of data where, for example, seismic interpretations may be tied to a well and/or subsequently inverted to obtain acoustic and/or elastic properties. Seismic migration can involve backpropagation (or continuation) of a seismic wavefield from a region where it was measured into a region for which an image and/or a model are to be generated. As an example, a framework may provide for applying plane wave derived amplitude correction terms based on an estimate of structural dip. In such an example, for complex models, structural dip may be estimated from a migrated image (e.g., and/or one or more other sources). Hence, as explained, dip, which is a characteristic of a subsurface geologic environment, can impact reflection seismology. And, dip may be deemed a characteristics to be elaborated by reflection seismology.

Acoustic full waveform inversion (FWI) is increasingly being pushed to make use of reflections. Reflections tend to have elastic effects that are difficult to match with an acoustic approximation and contribute to poor waveform matching and subsequent convergence problems. Whilst elastic FWI offers the potential to better invert reflections, and invert for elastic model parameters, it is orders of magnitude more computationally expensive if run with a grid sampling appropriate to generate dispersion-free shear wave propagation.

In various instances, an approach can use acoustic FWI to build a pressure wave (compressional wave) velocity model using diving wave high offset data and then fix the propagation velocity, restrict the offsets to near zero angle, and increase frequency, to invert for normal incidence “pseudo” reflectivity from the reflections. Such an approach can be considered as a non-linear least-squares migration as it can also make use of multiples. Further, it may be extended to produce prestack images by binning the data in offset (or potentially angle) and running acoustic FWI multiple times. The resulting images, as a function of offset or angle, can then be used for subsequent AVO/AVA analysis to extract elastic parameters (see, e.g., an article by Warner et al., Full-elastic AVA extraction using acoustic FWI. Second International Meeting for Applied Geoscience & Energy, Expanded Abstracts, 2022, which is incorporated by reference herein). If binning by offset, a substantial number of bins will be required to produce an accurate offset-to-angle transformation (e.g., usually performed via raytracing) required for detailed AVA analysis. An alternative approach can attempt to derive elastic amplitude corrections for acoustic modelling.

As an example, an approach suitable for use in various applications (e.g., FWI, etc.) can be based on plane-wave reflection coefficient mechanics. In such an approach, an acoustic wave equation can be derived that augments kinematic effects with terms that control linearized elastic reflection amplitude effects. Such an approach can be implemented optionally without running multiple propagations, as required in various other approaches. Hence, such an approach can improve performance of a reflection seismology system.

In an article by McLeman et al. (“Reflection FWI with an augmented wave equation and quasi-Newton adaptive gradient scheme”, First International Meeting for Applied Geoscience & Energy, Expanded Abstracts, 2021), which is incorporated by reference herein, elastic AVA effects are noted; however, issues exist in how this is elaborated, particularly with respect to physical realities and limitations. Proposed equations (e.g., Eqn. (4) and Eqn. (5)) do not properly account for physical realities and limitations; noting that examples to demonstrate how these equations could possibly assist with seismic analysis are lacking.

As an example, a method can account for plane-wave reflection coefficient mechanics where an acoustic wave equation can be derived that augments kinematic effects with terms that control linearized elastic reflection amplitude effects. For example, consider a method that includes representing an acoustic model using one or more velocity parameters and elastic vector reflectivity parameters; using an elastic plane-wave reflectivity equation to derive angle dependent amplitude correction terms; representing structural dip at which these amplitude corrections may be applied; selecting angles where one or more corrections are expected to be accurate enough (e.g., most likely in the pre-critical range); at each time step, using a wavefield propagation direction to calculate an incidence angle to the structural dip; and at each modelling time step, applying the angle-dependent amplitude correction terms after the kinematic effects have been modelled.

As to accounting for elasticity or elastics, a reflection coefficient or reflectivity can be used, which is the proportion of seismic wave amplitude reflected from an interface to the wave amplitude incident upon it. For example, if 10 percent of the amplitude is returned, then the reflection coefficient is 0.10. As an example, reflection coefficients (e.g., reflectivity) can be linearized to ease computations for elastic behaviors. For example, a method can include linearization of reflection coefficients as part of an approach to determine amplitude correction terms that can be applied to acoustically determined amplitudes. While a nonlinear approach can be performed to handle reflection coefficients, reflections coefficients can involve imaginary numbers beyond the critical angle, which introduce phase effects. As an example, where a nonlinear approach is implemented, it may be limited using one or more angle criteria (e.g., to limit to angles up to a critical angle).

As an example, such a method may provide for use of a linearized elastic plane-wave P-P reflectivity equation to derive angle dependent amplitude correction terms. As an example, the aforementioned method may include application of the amplitude correction terms as limited by a maximum angle (e.g., a maximum critical angle criterion). As an example, the aforementioned method may include kinematics modelled with acoustic anisotropy and amplitudes modelled as isotropic elastic effects. As an example, a method can include using resulting wavefields in a FWI workflow. As an example, a method can include using resulting wavefields in a FWI workflow to invert for elastic reflectivity parameters from P-wave data. As an example, a method can include subtracting resulting wavefields from elastic modelling pressure wavefields to obtain an estimate of converted waves. A converted wave can be a seismic wave that changes from a P-wave to an S-wave, or vice versa, when it encounters an interface (e.g., a reflector).

As explained, an elastic model that represents a geologic region can demand use of a relatively fine grid with substantial computational demand for wavefield simulation. As an example, an approach that supplements an acoustic model using a linearized elastic model can be implemented with comparatively less computational demand for wavefield simulation. In such an example, the linearized elastic model can be utilized to derive amplitude correction terms to be applied to an acoustic model (e.g., supplement amplitudes derived from the acoustic model). Where computational demand can be regulated with increased accuracy, utilization of such an approach can be effective for one or more workflows such as, for example, a FWI workflow. Hence, such an approach can improve a reflection seismology system.

As an example, an initial acoustic model may be built using acquired seismic data. For example, consider performing an acoustic FWI to invert the acquired seismic data to output an initial acoustic model. In such an example, the initial acoustic model may then become part of a seismic model that includes an acoustic portion and an elastic portion. Such a seismic model may be utilized to perform wavefield simulation to output one or more synthetic wavefields, which, in turn, may be utilized in another FWI (e.g., an elastic FWI) using the acquired seismic data to generate a refined model. As an example, an acoustic FWI may have a focus on diving waves to build an acoustic model, where such diving wave can have limited exposure to reflection and/or transmission effects. As a wavefield evolves, with primary reflections (primaries) and multiple reflections (multiples), the wavefield becomes progressively nonlinear as such reflections are sensitive to elastic effects. Hence, modelling of elastic behavior via elastic terms can improve accuracy. Such an approach can improve performance of a reflection seismology system.

As an example, a method can include assessing wavefield direction and determining a relationship between wavefield direction and one or more reflectors. During a wavefield simulation, at each time step (e.g., iteration), direction of a wavefield (e.g., traveling direction) can change whereby its direction can be assessed at each point (e.g., grid point) in a model and, as appropriate, be compared with respect to one or more reflectors, as may be represented in the model (e.g., material interfaces, etc.). As mentioned, one or more angle criteria can be applied for making amplitude corrections using elasticity-based determined amplitude correction terms. In such an approach, one or more angle criteria can be applied to one or more angles at one or more locations where such one or more angles can depend on direction of a simulated wavefield, as may change during wavefield simulation as time iteratively advances.

In various instances, a model can be static and structural dip of one or more reflectors therein can be static where direction of a wavefield can change during wavefield simulation. Where such an approach is integrated into an inversion (e.g., FWI), a model can be dynamic in that it may be updated based on an inversion result. For example, if one or more velocity parameter values are changed, which may affect structural dip, then the kinematics of a model can change (e.g., acoustic portion). In various workflows, a simulated wavefield or simulated wavefields may be integrated into model building and/or model refinement. As an example, a final model may be an output of a reflection seismology system where, for example, the final output may provide a model that includes accurate representations of reflectors and, as appropriate, structural dip.

As explained, a model may be referred to as a seismic model where the model includes an acoustic portion and an elastic portion. In such an example, the model can include various terms where the terms may be separable into acoustic terms for wavefield kinematics (e.g., as dependent on one or more velocity parameters, density parameters, etc.) and elastic terms for wavefield elastics. In such an example, a time step of a wavefield simulation can include determining wavefield amplitude using acoustic terms for wavefield kinematics and then applying wavefield amplitude corrections using elastic terms for wavefield elastics.

As an example, a method can utilize a seismic model that includes an acoustic portion and an elastic portion for wavefield simulation where such a wavefield simulation can generate a synthetic wavefield as an output, which can be a synthetic seismogram or synthetic seismograms. A seismogram can be defined as a collection of traces recorded from a single shot point where numerous seismograms can be displayed together in a single seismic section. As explained, a model can be used to generate synthetic seismograms that can then be compared to acquired seismograms from a seismic survey performed in the field for a geologic region. A comparison between synthetic and acquired seismograms can provide for generating a more accurate structural model of the geologic region (e.g., via FWI, etc.). In such an approach, a reflection seismology system can be improved, which, in turn, can improve drilling, well construction, production, etc., with respect to an identified reservoir within the geologic region.

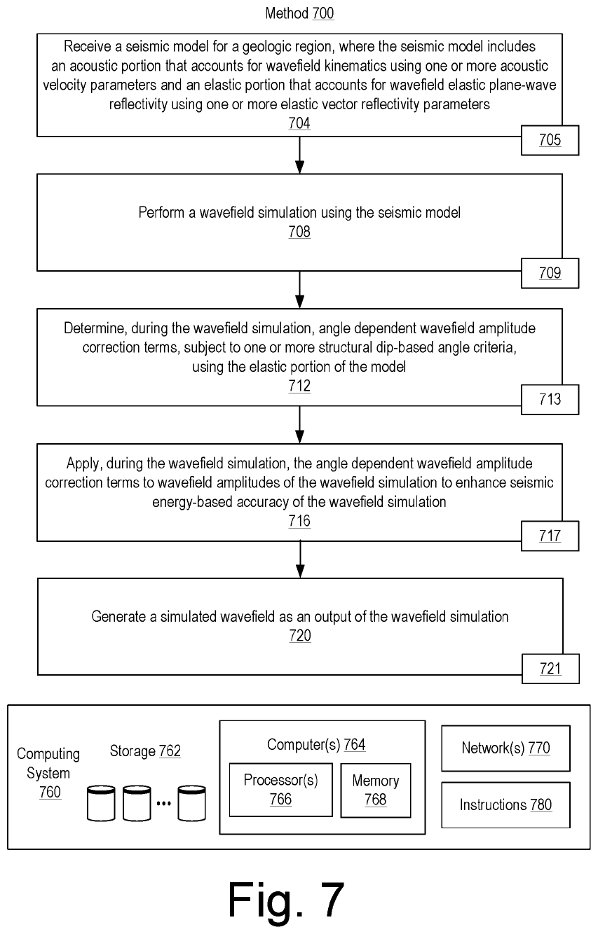

FIG. 7 shows an example of a method 700 that includes a reception block 704 for receiving a seismic model for a geologic region, where the seismic model includes an acoustic portion that accounts for wavefield kinematics using one or more acoustic velocity parameters and an elastic portion that accounts for wavefield elastic plane-wave reflectivity using one or more elastic vector reflectivity parameters; a performance block 708 for performing a wavefield simulation using the seismic model; a determination block 712 for, during the wavefield simulation, determining angle dependent wavefield amplitude correction terms, subject to one or more structural dip-based angle criteria, using the elastic portion of the model; an application block 716 for, during the wavefield simulation, applying the angle dependent wavefield amplitude correction terms to wavefield amplitudes of the wavefield simulation to enhance seismic energy-based accuracy of the wavefield simulation; and a generation block 720 for generating a simulated wavefield as an output of the wavefield simulation.

As an example, the method 700 of FIG. 7 may be utilized in a full-waveform inversion (FWI). For example, one or more generated wavefields can be used for FWI, which may be implemented by a framework that may be part of a reflection seismology system.

The method 700 is shown in FIG. 7 in association with various computer-readable media (CRM) blocks 705, 709, 713, 717 and 721. Such blocks generally include instructions suitable for execution by one or more processors (or cores) to instruct a computing device or system to perform one or more actions. While various blocks are shown, a single medium may be configured with instructions to allow for, at least in part, performance of various actions of the method 700 (e.g., using the computing system 760, etc.). A computer-readable medium (CRM) may be a computer-readable storage medium that is not a carrier wave, that is not a signal and that is non-transitory.

FIG. 7 shows the computing system 760 as including one or more information storage devices 762, one or more computers 764, one or more network interfaces 770 and instructions 780. As to the one or more computers 764, each computer may include one or more processors (or processing cores) 766 and memory 768 for storing instructions executable by at least one of the one or more processors. A computer may include one or more network interfaces (wired or wireless), one or more graphics cards, a display interface (wired or wireless), etc. A system may include one or more display devices (optionally as part of a computing device, etc.). Memory can be a computer-readable storage medium. A computer-readable storage medium is not a carrier wave, is not a signal and is non-transitory.

As explained, a linearized elastic model can be used to generate amplitude correction terms that can improve upon amplitudes generated using an acoustic model. In such an approach, amplitudes of a generated wavefield can more accurately represent acquired wavefields such that, for example, an objective function of a FWI can be driven to a lower value providing a better inversion result.

Linearized equations for elastic reflection coefficients may be accurate up to a particular angle, which can depend on the critical angle. For example, consider use of such equations up to approximately 30 degrees to approximately 40 degrees. While solutions to such equations can deviate from theoretical responses in instances beyond a critical angle or otherwise limiting angle, such equations can improve accuracy (e.g., as to amplitudes) and reduce computational demand compared to full elastic modelling. Hence, such an approach can improve a reflection seismology system.

As an example, a method can include estimating structural dip, which may be estimated via one or more techniques, such as, for example, via migration of acquired seismic data. As to one or more angle criteria, these can be between an estimated propagation angle of a wavefield and an estimated structural dip (e.g., consider structural dip with respect to reflection angle, etc.). As to estimating structural dip, such estimates can be performed at locations to which amplitude correction terms can be applied.

In Snell's law, the critical angle is the largest possible angle of incidence which still results in a refracted ray (e.g., where the refracted ray travels along the boundary between the two media). As an example, a method can include performing a wavefield simulation to determine a direction in which a wavefield is traveling and incident upon a reflector (e.g., an interface) where the reflector can be a dipping reflector that dips at a defined dip angle. As an example, a method may include determining a direction of a normal vector to a reflector that has an associated structural dip.

In reflection seismology, the Zoeppritz equations may be utilized, which describe partitioning of energy in a wavefield relative to its angle of incidence at a boundary across which properties of rock change and/or fluid content change (e.g., consider a change in acoustic impedance, etc.). The Zoeppritz equations relate amplitude of plane waves, incident upon a planar interface separating two isotropic media, and amplitude of reflected and refracted P- and S-waves to the angle of incidence. The Zoeppritz equations find use in investigating factors affecting amplitude of a returning seismic wave when the angle of incidence is altered (e.g., consider amplitude versus offset analysis), which can help to detect hydrocarbons in a geologic region.

As to an initial model, which may be referred to as a seismic model with an acoustic portion and an elastic portion, the acoustic portion may be built using field data. For example, consider using an FWI workflow to acoustically build an acoustic wave compressional model using acquired seismic data.

As an example, a method can provide for acoustic modelling with elastic AVA effects. As explained, reflections have elastic effects that can be difficult to match with an acoustic approximation and can contribute substantially residuals (e.g., errors). Whilst elastic FWI offers the potential to better invert reflections, and invert for elastic model parameters, it is orders of magnitude more computationally expensive if run with a grid sampling appropriate to generate dispersion free shear wave propagation. As explained, a method can include using a seismic model with an acoustic portion and an elastic portion where the elastic portion can be utilized to generate amplitude correction terms for amplitudes determined by the acoustic portion. In such an approach, the method can provide for acoustic modelling with elastic AVA effects.

As an example, a method can utilize an acoustic two-way wave equation modelling technique formulated in terms of velocity and reflectivity rather than velocity and density. For example, consider the following model:

$$\frac{{\partial }^{2} P}{\partial {t}^{2}} - \{ {V}_{P}^{2} {∇}^{2} P + {V}_{P} ∇ {V}_{P} \cdot ∇ P - 2 {V}_{P}^{2} ( R \cdot ∇ P ) \} = S \qquad ( 1 )$$

where P is pressure, V_{P} is velocity, S is the source, and R is a vector reflectivity.

In Eqn. (1), the first Laplacian term inside the curly brackets controls the propagation speed (kinematics) and the second two terms, comprised of gradients, control the amplitudes.

If the vector reflectivity is defined as the normalized rate of acoustic impedance change in each vector direction:

$$R = \frac{1}{2} \frac{∇ ( ρ {V}_{P} )}{ρ {V}_{P}} \qquad ( 2 )$$

where ρ denotes density.

Upon substitution of Eqn. (2) into Eqn. (1), the result is standard acoustic modelling:

$$\frac{{\partial }^{2} P}{\partial {t}^{2}} - {V}_{P}^{2} ρ ∇ \cdot ( \frac{1}{ρ} ∇ P ) = S \qquad ( 3 )$$

If acoustic impedance is constant spatially, the reflectivity is zero and Eqn. (1) degenerates to the non-reflecting wave equation (see, e.g., Baysal et al. (1984)).

Now consider replacing R in Eqn. (1) with R(θ), an angle dependent formulation that depends on elastic parameter contrasts and simulates AVA behavior for reflections. In such an example, a result is not as simple as plugging in a formula for PP plane-wave reflection coefficients, which can be demonstrated using the Aki-Richards linearized PP reflection coefficient equation (see, e.g., Aki & Richards, 1980), denoting shear wave velocity as V_{S}. This equation can be written as:

$${R}_{P P} ( θ ) = ( 1 - 4 C {sin}^{2} θ ) {R}_{AI} + ( 8 C {sin}^{2} θ ) {R}_{VPVSRatio} + ( \frac{1}{{cos}^{2} θ} - 1 - 4 C {sin}^{2} θ ) {R}_{{V}_{P}} \qquad ( 4 )$$

$$where$$

$$C = {( \frac{{V}_{s}}{{V}_{P}} )}^{2} ,$$

θ is the average angle, and

$${R}_{AI} = \frac{1}{2} \frac{∇ ( ρ {V}_{P} )}{ρ {V}_{P}} , {R}_{VPVSRatio} = \frac{1}{2} \frac{∇ ( {V}_{P} / {V}_{S} )}{{V}_{P} / {V}_{S}} , {R}_{{V}_{P}} = \frac{1}{2} \frac{∇ {V}_{P}}{{V}_{P}} .$$

For an acoustic model (V_{S}=0, C=0), Eqn. (4) reduces to:

$${R}_{P P} ( θ ) = {R}_{AI} + ( \frac{1}{{cos}^{2} θ} - 1 ) {R}_{{V}_{P}} . \qquad ( 5 )$$

For acoustic modelling, the acoustic impedance vector reflectivity, R_{AI}, as R can be placed in Eqn. (1) to simulate correct amplitude effects. Plugging in the vector reflectivity equivalent of Eqn. (5) is not appropriate. Based on this insight, now consider modifying the vector reflectivity equivalent of Eqn. (4). Consider defining

$$R ( θ ) = {R}_{P P} ( θ ) - ( \frac{1}{{cos}^{2} θ} - 1 ) {R}_{{V}_{P}}$$

to give:

$$R ( θ ) = ( 1 - 4 C {sin}^{2} θ ) {R}_{AI} + ( 8 C {sin}^{2} θ ) {R}_{VPVSRatio} - ( 4 C {sin}^{2} θ ) {R}_{{V}_{P}} . \qquad ( 6 )$$

Plugging Eqn. (6) into Eqn. (1) gives:

$$\frac{{\partial }^{2} P}{\partial {t}^{2}} - {V}_{P}^{2} {∇}^{2} P + 2 {V}_{P}^{2} \{ ( 1 - 4 C {sin}^{2} θ ) {R}_{AI} + ( 8 C {sin}^{2} θ ) {R}_{VPVSRatio} - ( 1 + 4 C {sin}^{2} θ ) {R}_{{V}_{P}} \} \cdot ∇ P = S \qquad ( 7 )$$

Just as in Eqn. (1) the Laplacian term controls the kinematics and the remaining terms control the amplitude effects. These amplitude effects may be used to simulate linearized elastic AVA reflection effects.

Linearized Aki-Richards reflection coefficients are not applicable beyond the critical angle. Furthermore, they can deviate from Zoeppritz calculations, most noticeably at large pre-critical angles. Therefore, as explained, a method can limit the angle used when practically implementing Eqn. (7). As an example, the elastic model can be analyzed to precompute the reflectivity terms and the limiting angle before propagation. The directivity terms in Eqn. (7) cannot be precomputed as they depend upon the wavefield direction. As an example, a method can use the Poynting vector and the structural dip to calculate sin² θ (see, e.g., Eqn. (6) and Eqn. (7)).

In various trials, comparisons can be made between elastic, acoustic and acoustic AVA modelling.

As an example, a pressure wavefield can be extracted from elastic finite-difference modelling by applying a divergence operator to particle velocities. To help ensure a rigorous comparison of 2D elastic, acoustic and acoustic AVA modelling, these three approaches can be implemented using a staggered grid of first-order equations. For acoustic modelling, there are three wavefield variables (two particle velocities and pressure) and, for elastic modelling, there are five variables (two particle velocities and three stresses). Details of a staggered grid implementation may be found, for example, in Virieux (1986). Pressure wavefields to be compared can be extracted in a consistent manner. For an acoustic model, simulations with the three schemes match to floating-point precision.

When running acoustic AVA modelling using Eqn. (7), an angle criterion can be, for example, to limit the angle using the critical angle.

In various trials, half-space experiments were performed. To demonstrate the ability of modelling using Eqn. (7) to simulate elastic AVA effects on reflected pressure wavefields, a relatively simple half-space model can be utilized.

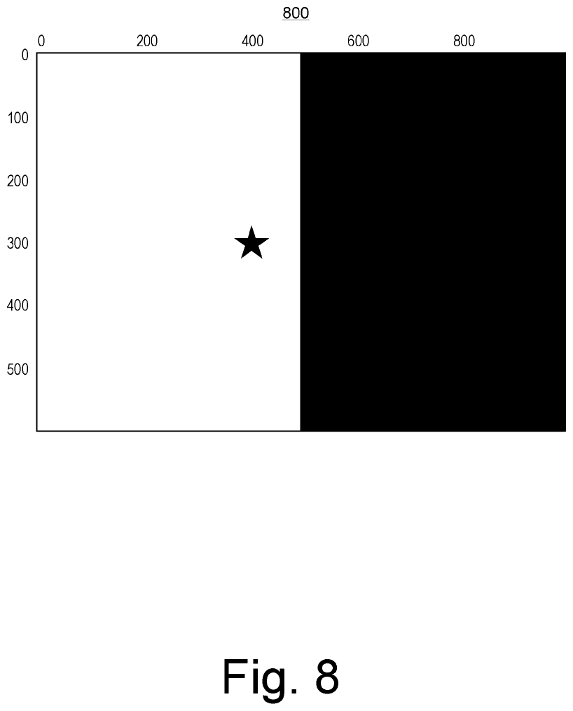

FIG. 8 shows an example of a half-space model 800 where, for example, the model can be 1000 m by 600 m model and sampled on a 1 m grid. In such an example, a method can conduct point source modelling, placing the source 100 m from the vertical interface in the center of the model, which is sufficiently far-field to see the effect of the plane-wave reflection coefficients used to derive Eqn. (7). For purposes of simulation, a Ricker wavelet with a peak frequency of 80 Hz is used as the source function. The simulation can capture the pressure wavefield snapshot before the wavefront impinges on the edge of the computational domain.

Simulations were performed using five models, as detailed in Table 1, below.

TABLE 1
Example models 1 to 5.

| | | | | | Left medium | | | Right medium | | |
|---|---|---|---|---|---|---|---|---|---|---|
| Model | | Contrasts | | | V_{P} | V_{S} | ρ | V_{P} | V_{S} | ρ |
| Number | Description | ρV_{P} | V_{P}/V_{S} | V_{P} | (m/s) | (m/s) | (kg/m³) | (m/s) | (m/s) | (kg/m³) |
| 1 | acoustic | yes | no | yes | 1500 | 0 | 1000 | 2000 | 0 | 2000 |
| 2 | elastic | yes | no | yes | 1500 | 750 | 1000 | 2000 | 1000 | 1000 |
| 3 | elastic | no | yes | no | 1500 | 1000 | 1000 | 1500 | 750 | 1000 |
| 4 | elastic | yes | yes | yes | 2000 | 1600 | 1000 | 1333.3 | 1000 | 1000 |
| 5 | elastic | no | no | yes | 1500 | 750 | 2000 | 2000 | 1000 | 1500 |

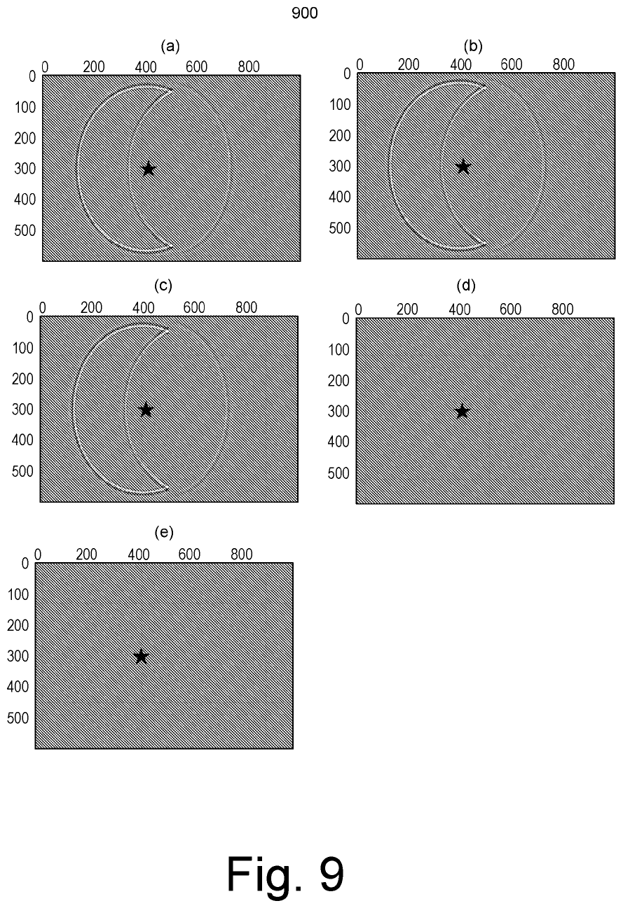

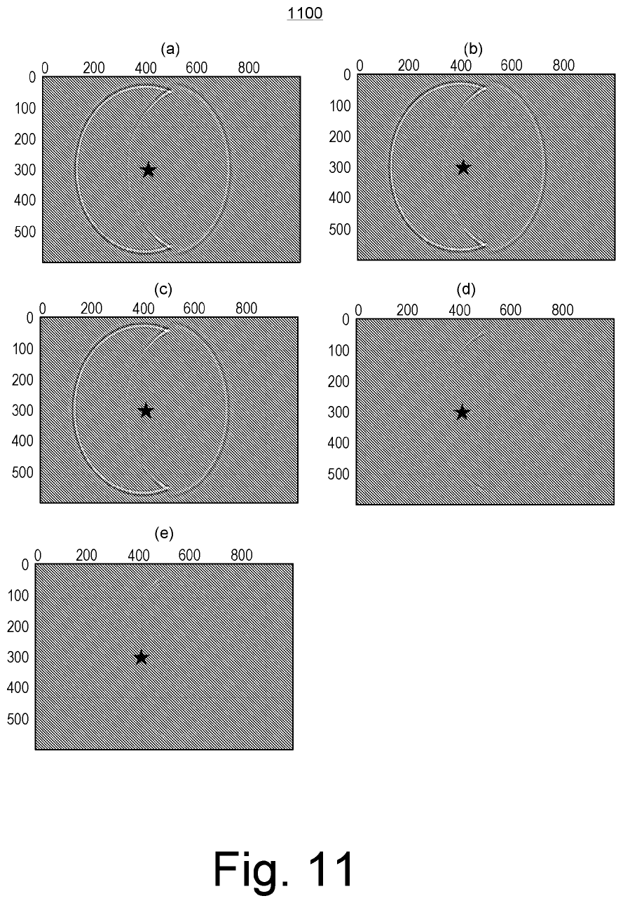

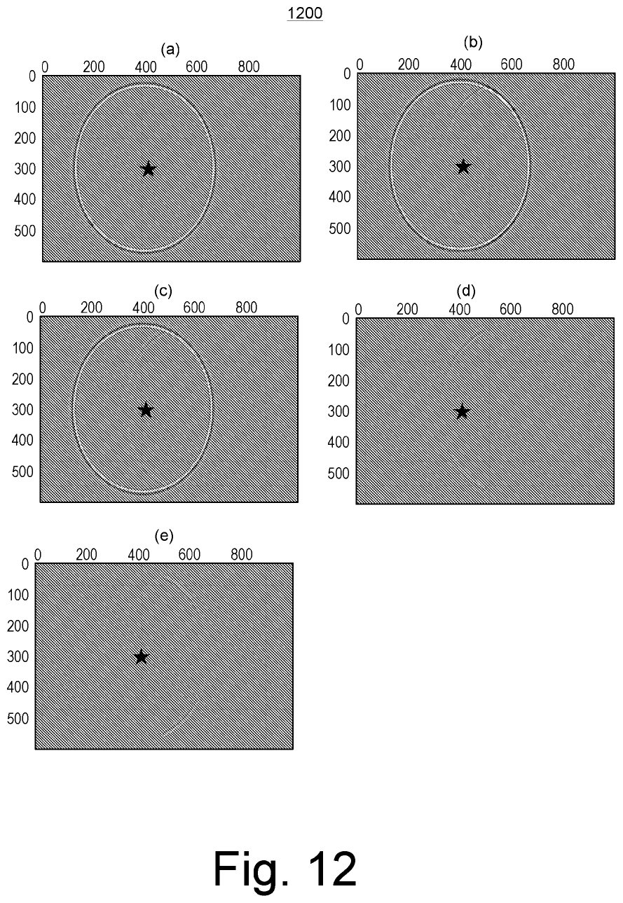

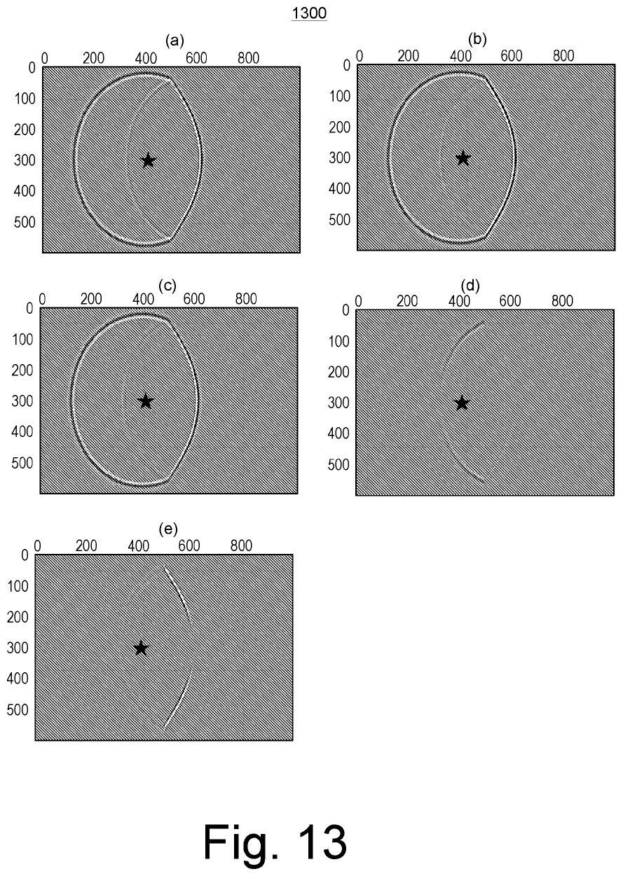

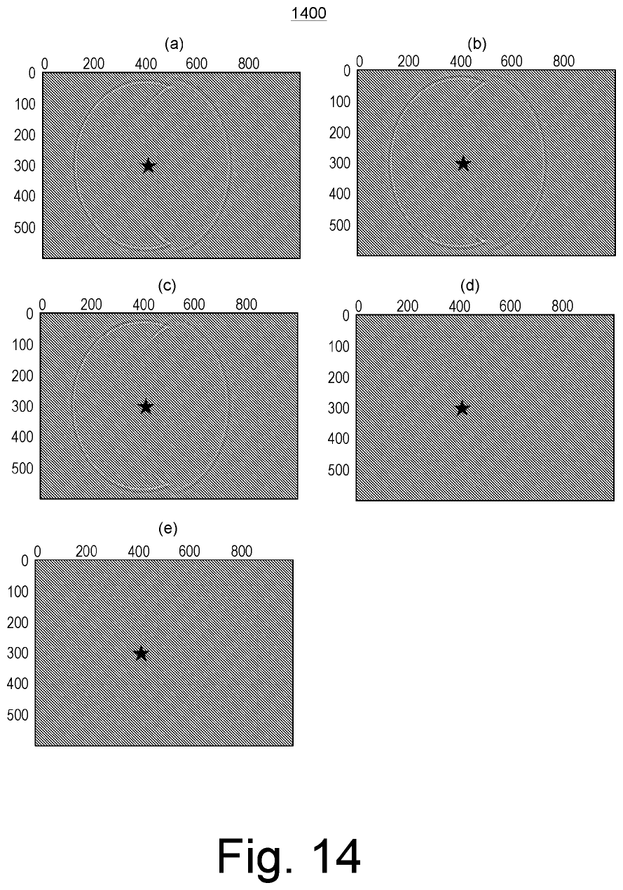

FIG. 9 shows simulation results 900 for three simulations using model 1. As indicated in Table 1, model 1 is an acoustic model and per FIG. 9, the three simulations give the same result. In FIG. 9, the images (a) to (e) correspond to acoustic, acoustic AVA, elastic, elastic minus acoustic and elastic minus acoustic AVA wavefields. In FIGS. 11, 12, 13 and 14, simulation results 1100, 1200, 1300 and 1400, respectively, are shown for the other four models (models 2, 3, 4 and 5), which, per Table 1, are elastic models. The elastic models 2 to 5 are defined to trigger different amplitude terms in Eqn. (7).

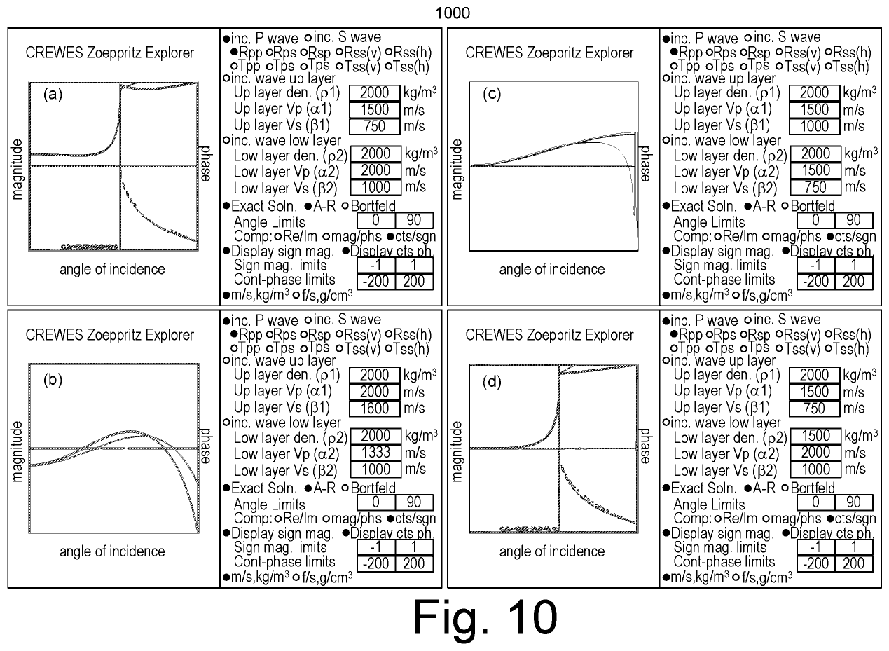

FIG. 10 shows examples of graphical user interfaces (GUIs) with associated plots 1000, labelled (a) to (d), for Zoeppritz computations. The plane-wave PP reflection coefficients as a function of incidence angle for each of these elastic models 2, 3, 4 and 5 correspond to the labels (a), (b), (c) and (d), respectively.

As shown in FIG. 10, a Zoeppritz computation (thicker curve) and the Aki-Richards calculation (thinner curve) are plotted as well as the critical angle. As mentioned, the finite-difference modelling simulation results for each of the four elastic models 2, 3, 4 and 5 are shown in FIGS. 11, 12, 13 and 14, respectively. The behavior of the acoustic AVA modelling follows the behavior expected from the associated plots of the GUIs 1000 of FIG. 10. The difference with elastic modelling on the reflected wave is substantially reduced in these cases compared to the difference between elastic and acoustic modelling. Note that the approach is not expected to drive the difference to zero due to the angle limiting and the accuracy of the Aki-Richards AVA equation when compared to Zoeppritz modelling. The simulations of model 4 (an AVO class II) show the polarity reversal at a slightly higher angle in the acoustic AVA modelling compared to the elastic modelling. This is also predicted as shown in the plot labelled (c) in FIG. 10.

Whilst it is possible to modify the reflected pressure wave amplitudes to more closely match elastic modelling, it is also possible to modify the transmitted pressure wave amplitudes. Unlike elastic modelling, there is no modelling of mode conversions such that there is no expectation to necessarily improve the match to the transmitted pressure wavefield from elastic modelling.

Various layered model experiments were also performed. In these experiments, a shot gather is modelled in an elastic layered model based on field data from an acquired 1D well log where a downhole tool acquired data as to formation properties. The model is 6 km wide and has a maximum depth of 3.2 km, with the deepest reflector at 3 km. There is a water layer down to a depth of 500 m.

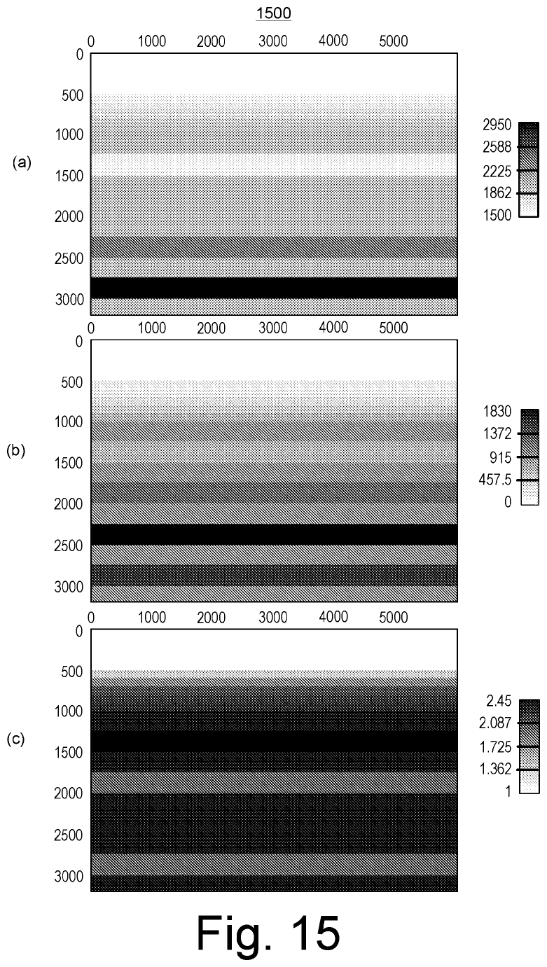

FIG. 15 shows the example model 1500 in a series of plots, labelled (a), (b) and (c) for properties V_{P}, V_{S} and ρ of the model 1500, which is sampled one a 1 meter grid. The contrasts present in the model cover four AVO classes. As to boundary conditions, a sponge absorbing boundary condition with a thickness of 90 m is implemented on the four edges. The source is placed at (3000 m, 92 m) and receivers every 1 m at a depth of 92 m. This geometry has a maximum offset of 3 km. A Ricker wavelet with a peak frequency of 15 Hz is employed. The simulation iterated in time for 3.5 s, which is long enough to record the reflection from the deepest reflector.

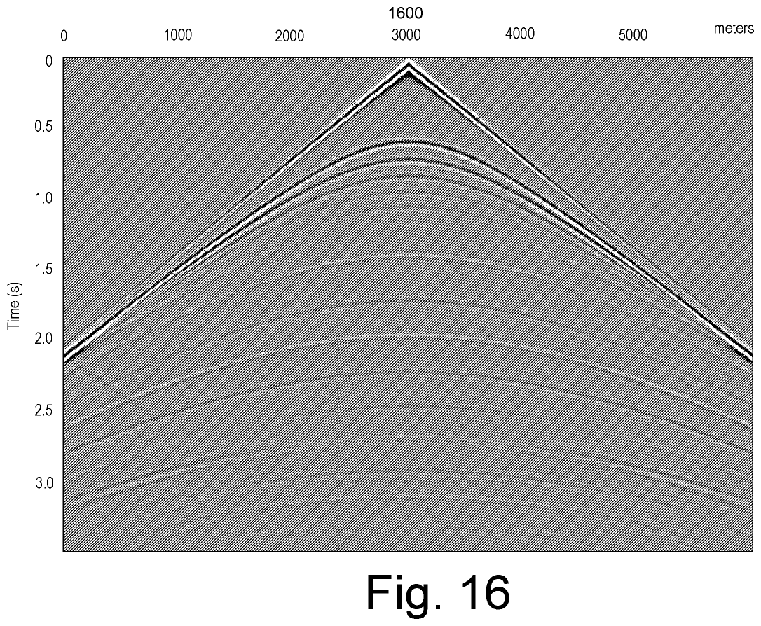

FIG. 16 shows an example image 1600 of a pressure shot gather from elastic modelling (e.g., shown as horizontal position versus time). In FIG. 16, the image 1600 is from a simulated seismic acquisition from a source positioned in the center with receivers extending laterally to each side, at distances outwardly from the center. In the image 1600, the different AVO classes can be seen. As well as internal multiples, there is clear evidence of lower frequency mode converted energy. In the example image 1600, various indicia of polarity reversals are present.

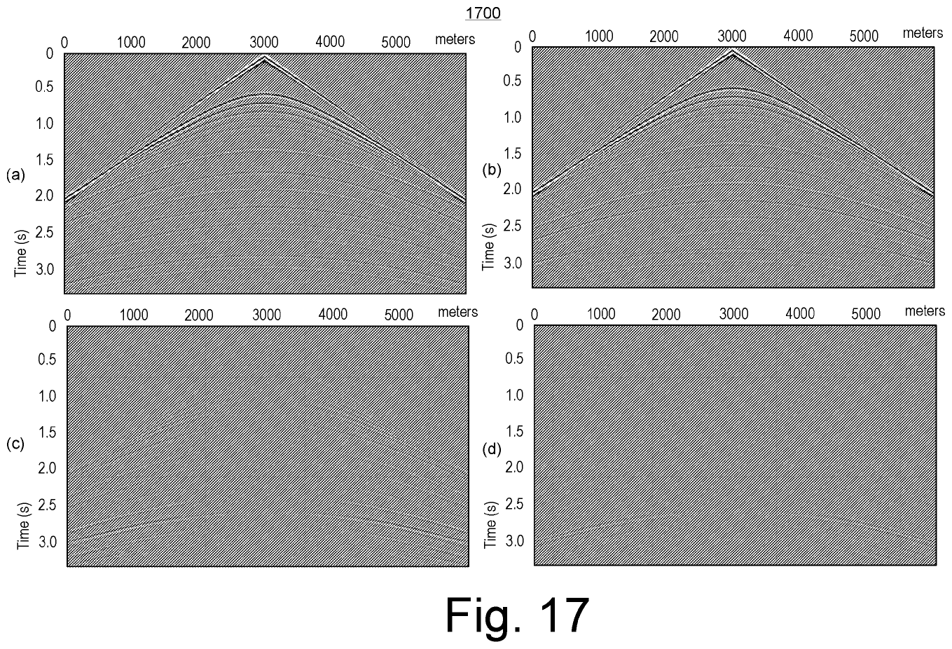

FIG. 17 shows example images 1700 from acoustic and acoustic AVA modelling and their differences with the elastic modelling result in FIG. 16. Specifically, FIG. 17 shows the images 1700 as shot gathers from modelling in the layered model in FIG. 16, labelled as follows: (a) acoustic; (b) acoustic AVA; (c) elastic minus acoustic; and (d) elastic minus acoustic AVA. The images 1700 are displayed on the same scale. Clearly, the difference between acoustic AVA modelling and elastic modelling, shown in the image labelled (d), is substantially less than the difference between acoustic modelling and elastic modelling, shown in the image labelled (c). The energy remaining in the image labelled (d) is mostly converted wave energy that the acoustic AVA modelling does not model.

In the experiment of FIG. 16, if a receiver is a greater distance from the source, it will capture energy from higher incidence angles, where a zero incidence angle can be defined as a vertical arrangement of a source and a receiver. At a zero angle, there can be lesser difference between acoustic modeling and elastic modeling. With greater offsets, the residuals (e.g., differences) generally increase between the acoustic waveforms and the elastic waveforms. Specifically, with elastic modeling, the higher angles associated with increased offsets can be more accurately modeled. In various examples, a residual plot or image (e.g., of differences) can reveal converted wave energy.

As explained, a normal incidence angle reflection (e.g., normal to a reflector) is dictated by an acoustic part; whereas, non-normal incidence angle reflections involve an elastic part. As various types of seismic surveys involve the latter, an approach that can supplement an acoustic model with an elastic model can improve results of such seismic surveys. As explained, AVO/AVA types of seismic surveys can inherently depend in part or in whole on non-normal incidence. In various examples, a method can include using a velocity model that is smooth or not smooth. As explained with respect to the model 1500, various parameters may vary abruptly and/or otherwise, as may be appropriate given field data.

For the implementation used in the experiments shown, and precomputing all of the model related quantities, there is a 3× increase in the memory requirements for acoustic AVA modelling over acoustic modelling and a 2× increase in the CPU time of the propagator. Whilst various experiments involved choosing to implement acoustic AVA modelling with a staggered grid of first-order equations, it is possible to implement it with a second-order scheme (e.g., or higher order scheme).

As an example, anisotropic acoustic AVA simulations can be performed by replacing the Laplacian term in Eqn. (7), that controls the kinematics, with an anisotropic propagator, and applying the isotropic AVA amplitude terms. In this case the memory and cost increases over the corresponding anisotropic acoustic modelling would be reduced.

Some “dispersion like” effects are noticeable on some of the experiments at angles beyond the critical angle where the linearized AVA equations employed may not be entirely valid. Furthermore, the Poynting vector estimates a single wavefield direction at any point in space and time. In the presence of multipathing, the angle estimated to calculate the reflectivity may be erroneous and contribute to the creation of the “dispersion like” effects. As an example, a method may provide for suppression of these effects; noting that in some instances in complex models, where wavefield propagation is quite complex, these effects may be problematic.

In various examples, application of the plane wave derived amplitude correction terms involves an estimate of structural dip. Whilst in the experiments shown, such an estimate is relatively straightforward, for more complex models structural dip may be estimated from a migrated image, field data (e.g., well log data), etc. As to well logs, data from multiple wells in a field may provide for determining formation tops, which may correspond to reflectors, where comparing depths of such formation tops may provide data as to structural dip.

As an example, one or more alternative parameterizations of the amplitude terms may be performed, for example, consider acoustic impedance, V_{P}/V_{S}, and density or shear velocity and density.

For use within FWI, the gradients with respect to AVA parameters can be computed by accumulating contributions from the gradient of R in Eqn. (1), scaled by the appropriate directivity term from Eqn. (7).

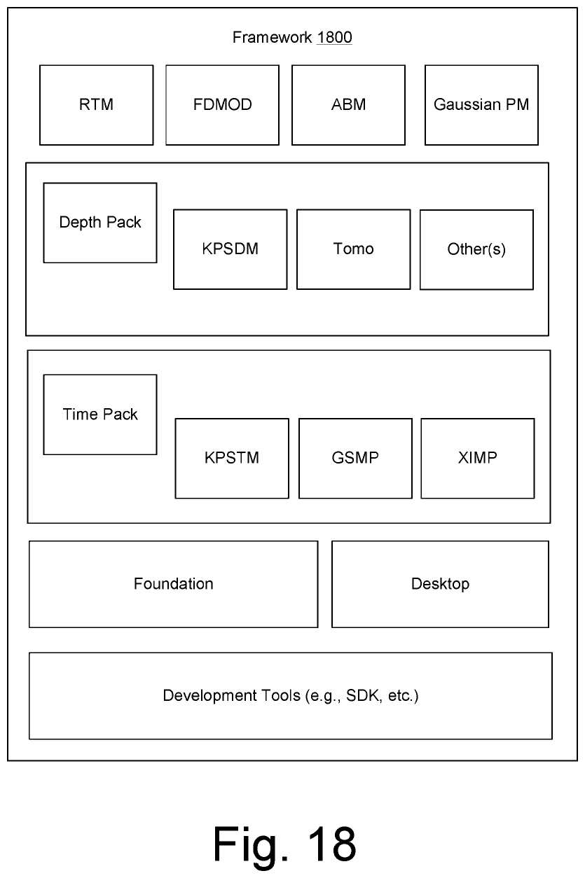

FIG. 18 shows an example of a computational framework 1800 that can include one or more processors and memory, as well as, for example, one or more interfaces. The blocks of the computational framework 1800 may be provided as instructions such as the instructions 780 of the system 760 of FIG. 7, etc. The computational framework of FIG. 18 can include one or more features of the OMEGA framework, which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, symmetry axis, and variable density.

As shown in FIG. 18, the computational framework 1800 includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools.

The framework 1800 can include features for geophysics data processing. The framework 1800 can allow for processing various types of data such as, for example, one or more of: land, marine, and transition zone data; time and depth data; 2D, 3D, and 4D surveys; isotropic and anisotropic (TTI and VTI) velocity fields; and multicomponent data.

The framework 1800 can allow for transforming seismic, electromagnetic, microseismic, and/or vertical seismic profile (VSP) data into actionable information, for example, to perform one or more actions in the field for purposes of resource production, etc. The framework 1800 can extend workflows into reservoir characterization and earth modelling. For example, the framework 1800 can extend geophysics data processing into reservoir modelling by integrating with the PETREL framework via the Earth Model Building (EMB) tools, which enable a variety of depth imaging workflows, including model building, editing and updating, depth-tomography QC, residual moveout analysis, and volumetric common-image-point (CIP) pick QC. Such functionalities, in conjunction with depth tomography and migration algorithms of the framework 1800 can produce accurate and precise images of the subsurface. The framework 1800 may provide support for field to final imaging, to prestack seismic interpretation and quantitative interpretation, from exploration to development.

As an example, the FDMOD component can be instantiated via one or more CPUs and/or one or more GPUs for one or more purposes. For example, consider utilizing the FDMOD for generating synthetic shot gathers by using full 3D, two-way wavefield extrapolation modelling, the same wavefield extrapolation logic matches that are used by RTM. FDMOD can model various aspects and effects of wave propagation. The output from FDMOD can be or include synthetic shot gathers including direct arrivals, primaries, surface multiples, and interbed multiples. The model can be specified on a dense 3D grid as velocity and optionally as anisotropy, dip, and variable density. As an example, survey designs can be modelled to ensure quality of a seismic survey, which may account for structural complexity of the model. Such an approach can enable evaluation of how well a target zone will be illuminated. Such an approach may be part of a quality control process (e.g., task) as part of a seismic workflow. As an example, a FDMOD approach may be specified as to size, which may be model size (e.g., a grid cell model size). Such a parameter can be utilized in determining resources to be allocated to perform a FDMOD related processing task. For example, a relationship between model size and CPUs, GPUs, etc., may be established for purposes of generating results in a desired amount of time, which may be part of a plan (e.g., a schedule) for a seismic interpretation workflow.

As an example, as survey data become available, interpretation tasks may be performed for building, adjusting, etc., one or more models of a geologic environment. For example, consider a vessel that transmits a portion of acquired data while at sea and that transmits a portion of acquired data while in port, which may include physically offloading one or more storage devices and transporting such one or more storage devices to an onshore site that includes equipment operatively coupled to one or more networks (e.g., cable, etc.). As data are available, options exist for tasks to be performed.

As an example, the framework 1800 can include one or more sets of instructions executable to perform one or more methods such as, for example, one or more of methods (e.g., consider the method 700 of FIG. 7, etc.). As an example, the framework 1800 may be part of a reflection seismology system, which, as explained, may be a distributed system.

As an example, a method can include receiving a seismic model for a geologic region, where the seismic model includes an acoustic portion that accounts for wavefield kinematics using one or more acoustic velocity parameters and an elastic portion that accounts for wavefield elastic plane-wave reflectivity using one or more elastic vector reflectivity parameters; performing a wavefield simulation using the seismic model; during the wavefield simulation, determining angle dependent wavefield amplitude correction terms, subject to one or more structural dip-based angle criteria, using the elastic portion of the model; during the wavefield simulation, applying the angle dependent wavefield amplitude correction terms to wavefield amplitudes of the wavefield simulation to enhance seismic energy-based accuracy of the wavefield simulation; and generating a simulated wavefield as an output of the wavefield simulation. In such an example, the one or more structural dip-based angle criteria can account for a critical angle. For example, the critical angle can represent a maximum angle, beyond which accuracy may be diminished.

As an example, a method can include performing a full-waveform inversion using one or more simulated wavefields.

As an example, a wavefield simulation can be an iterative simulation with respect to advancing increments in time. In such an example, a method can include applying angle dependent wavefield amplitude correction terms to wavefield amplitudes of the wavefield simulation to enhance seismic energy-based accuracy of the wavefield simulation at each increment after modelling of the wavefield kinematics.

As an example, a method can include determining structural dip in one or more portions of the geologic region. For example, consider using one or more tools, data, interpretation, modeling, etc., to determine (e.g., estimate, etc.) structural dip.

As an example, a method can include building a seismic model using field data acquired for the geologic region.

As an example, a method can include using a seismic model where an elastic portion includes a linearized elastic plane-wave PP reflectivity model. In such an example, the method can include determining angle dependent wavefield amplitude correction terms via implementation of the linearized elastic plane-wave PP reflectivity model.

As an example, a method can utilize one or more structural dip-based angle criteria that can include a maximum angle as a limit. As explained, a limit may account for one or more phenomena that may tend to diminish accuracy of a model or a portion thereof.

As an example, a method can include a model that can represent wavefield kinematics, for example, as modelled with acoustic anisotropy where, for example, wavefield amplitudes are modelled as isotropic elastic effects.

As an example, a method can include performing a full-waveform inversion using a simulated wavefield to invert for at least one of one or more elastic reflectivity parameters using acquired P-wave seismic survey data.

As an example, a method can include subtracting a simulated wavefield from an elastic modelling pressure wavefield to generate an estimate for one or more converted waves.

As an example, a method can include performing a simulation by, at least part, implementing a finite difference solver for a defined wavefield simulation grid. In such an example, the defined wavefield simulation grid can include grid parameters that determine in part a computational demand. In such an example, the computational demand can be less than a computational demand of a full elastic seismic model.

As an example, a method can utilize a seismic model that includes or that is a hybrid acoustic and elastic seismic model that depends on one or more structural dip-based angle criteria (e.g., consider one or more critical angle criteria for one or more reflectors, which may be dipping).

As an example, a method can include performing a wavefield simulation that performs the wavefield simulation according to a defined seismic survey geometry. As an example, a defined seismic survey geometry corresponds to an amplitude variation with angle (AVA) seismic survey geometry. In such an example, a simulated wavefield may be a common midpoint (CMP) gather wavefield.

As an example, a method can include identifying a presence of hydrocarbons in a geologic region using a simulated wavefield.

As an example, a method can include generating an image of a geologic region using a simulated wavefield.

As an example, a method can include generating a seismic survey geometry using a simulated wavefield.

As an example, a system can include a processor; memory operatively coupled to the processor; and processor-executable instructions stored in the memory to instruct the system to: receive a seismic model for a geologic region, where the seismic model includes an acoustic portion that accounts for wavefield kinematics using one or more acoustic velocity parameters and an elastic portion that accounts for wavefield elastic plane-wave reflectivity using one or more elastic vector reflectivity parameters; perform a wavefield simulation using the seismic model; during the wavefield simulation, determine angle dependent wavefield amplitude correction terms, subject to one or more structural dip-based angle criteria, using the elastic portion of the model; during the wavefield simulation, apply the angle dependent wavefield amplitude correction terms to wavefield amplitudes of the wavefield simulation to enhance seismic energy-based accuracy of the wavefield simulation; and generate a simulated wavefield as an output of the wavefield simulation.

As an example, one or more computer-readable storage media can include computer-executable instructions executable to instruct a computing system to: receive a seismic model for a geologic region, where the seismic model includes an acoustic portion that accounts for wavefield kinematics using one or more acoustic velocity parameters and an elastic portion that accounts for wavefield elastic plane-wave reflectivity using one or more elastic vector reflectivity parameters; perform a wavefield simulation using the seismic model; during the wavefield simulation, determine angle dependent wavefield amplitude correction terms, subject to one or more structural dip-based angle criteria, using the elastic portion of the model; during the wavefield simulation, apply the angle dependent wavefield amplitude correction terms to wavefield amplitudes of the wavefield simulation to enhance seismic energy-based accuracy of the wavefield simulation; and generate a simulated wavefield as an output of the wavefield simulation.

As an example, a computer program product can include computer-executable instructions to instruct a computing system to perform a method or methods, for example, consider a method such as the method 700 of FIG. 7, etc.

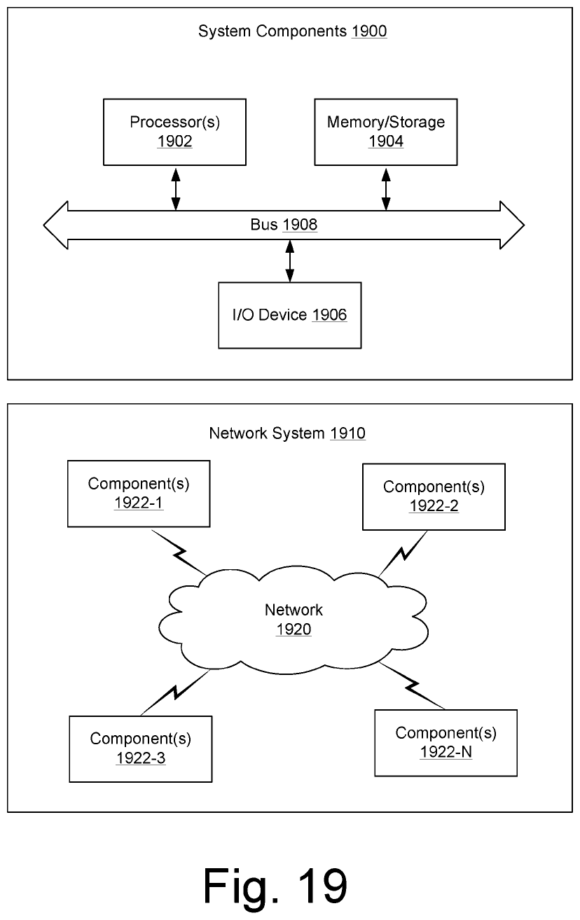

FIG. 19 shows components of a computing system 1900 and a networked system 1910 that includes a network 1920. The system 1900 includes one or more processors 1902, memory and/or storage components 1904, one or more input and/or output devices 1906 and a bus 1908. Instructions may be stored in one or more computer-readable media (memory/storage components 1904). Such instructions may be read by one or more processors (see the processor(s) 1902) via a communication bus (see the bus 1908), which may be wired or wireless. The one or more processors may execute such instructions to implement (wholly or in part) one or more attributes (as part of a method). A user may view output from and interact with a process via an I/O device (see the device 1906). A computer-readable medium may be a storage component such as a physical memory storage device such as a chip, a chip on a package, a memory card, etc. (a computer-readable storage medium).

Components may be distributed, such as in the network system 1910. The network system 1910 includes components 1922-1, 1922-2, 1922-3, . . . 1922-N. The components 1922-1 may include the processor(s) 1902 while the component(s) 1922-3 may include memory accessible by the processor(s) 1902. Further, the component(s) 1922-2 may include an I/O device for display and optionally interaction with a method. The network may be or include the Internet, an intranet, a cellular network, a satellite network, etc.

A device may be a mobile device that includes one or more network interfaces for communication of information. A mobile device may include a wireless network interface (operable via IEEE 802.11, ETSI GSM, BLUETOOTH®, satellite, etc.). A mobile device may include components such as a main processor, memory, a display, display graphics circuitry (optionally including touch and gesture circuitry), a SIM slot, audio/video circuitry, motion processing circuitry (accelerometer, gyroscope), wireless LAN circuitry, smart card circuitry, transmitter circuitry, GPS circuitry, and a battery. A mobile device may be configured as a cell phone, a tablet, etc. A method may be implemented (wholly or in part) using a mobile device. A system may include one or more mobile devices.

A system may be a distributed environment such as a so-called “cloud” environment where various devices, components, etc. interact for purposes of data storage, communications, computing, etc. A device or a system may include one or more components for communication of information via one or more of the Internet (where communication occurs via one or more Internet protocols), a cellular network, a satellite network, etc. A method may be implemented in a distributed environment (wholly or in part as a cloud-based service).

Information may be input from a display (consider a touchscreen), output to a display or both. Information may be output to a projector, a laser device, a printer, etc. such that the information may be viewed. Information may be output stereographically or holographically. As to a printer, consider a 2D or a 3D printer. A 3D printer may include one or more substances that can be output to construct a 3D object. Data may be provided to a 3D printer to construct a 3D representation of a subterranean formation. Layers may be constructed in 3D (horizons, etc.), geobodies constructed in 3D, etc. Holes, fractures, etc., may be constructed in 3D (as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving a seismic model for a geologic region, the seismic model includes an acoustic portion that accounts for wavefield kinematics using one or more acoustic velocity parameters and an elastic portion that accounts for wavefield elastic plane-wave reflectivity using one or more elastic vector reflectivity parameters;
performing a wavefield simulation using the seismic model;
during the wavefield simulation, determining angle dependent wavefield amplitude correction terms, subject to one or more structural dip-based angle criteria, using the elastic portion of the model;
during the wavefield simulation, applying the angle dependent wavefield amplitude correction terms to wavefield amplitudes of the wavefield simulation to enhance seismic energy-based accuracy of the wavefield simulation; and
generating a simulated wavefield as an output of the wavefield simulation.

2. The method of claim 1, wherein the one or more structural dip-based angle criteria account for a critical angle.

3. The method of claim 1, comprising performing a full-waveform inversion using the simulated wavefield.

4. The method of claim 1, wherein the wavefield simulation includes an iterative simulation with respect to advancing increments in time, the applying occurs at each increment after modelling of the wavefield kinematics.

5. The method of claim 1, comprising determining structural dip in one or more portions of the geologic region.

6. The method of claim 1, comprising building the seismic model using field data acquired for the geologic region.

7. The method of claim 1, wherein the elastic portion includes a linearized elastic plane-wave PP reflectivity model, the determining the angle dependent wavefield amplitude correction terms implements the linearized elastic plane-wave PP reflectivity model.

8. The method of claim 1, wherein the one or more structural dip-based angle criteria include a maximum angle as a limit.

9. The method of claim 1, wherein the wavefield kinematics are modelled with acoustic anisotropy and wavefield amplitudes are modelled as isotropic elastic effects.

10. The method of claim 1, comprising performing a full-waveform inversion using the simulated wavefield to invert for at least one of the one or more elastic reflectivity parameters using acquired P-wave seismic survey data.

11. The method of claim 1, comprising subtracting the simulated wavefield from an elastic modelling pressure wavefield to generate an estimate for one or more converted waves.

12. The method of claim 1, wherein performing the simulation includes implementing a finite difference solver for a defined wavefield simulation grid.

13. The method of claim 12, wherein the defined wavefield simulation grid includes grid parameters that determine in part a computational demand and the computational demand is less than a computational demand of a full elastic seismic model.

14. The method of claim 1, wherein the seismic model includes a hybrid acoustic and elastic seismic model that depends on the one or more structural dip-based angle criteria.

15. The method of claim 1, wherein performing the wavefield simulation performs the wavefield simulation according to a defined seismic survey geometry, the defined seismic survey geometry corresponds to an amplitude variation with angle (AVA) seismic survey geometry, and the simulated wavefield includes a common midpoint (CMP) gather wavefield.

16. The method of claim 1, comprising identifying a presence of hydrocarbons in the geologic region using the simulated wavefield.

17. The method of claim 1, comprising generating an image of the geologic region using the simulated wavefield.

18. The method of claim 1, comprising generating a seismic survey geometry using the simulated wavefield.

19. A system comprising:
a processor;
memory operatively coupled to the processor; and
processor-executable instructions stored in the memory to instruct the system to:
receive a seismic model for a geologic region, the seismic model includes an acoustic portion that accounts for wavefield kinematics using one or more acoustic velocity parameters and an elastic portion that accounts for wavefield elastic plane-wave reflectivity using one or more elastic vector reflectivity parameters;
perform a wavefield simulation using the seismic model;
during the wavefield simulation, determine angle dependent wavefield amplitude correction terms, subject to one or more structural dip-based angle criteria, using the elastic portion of the model;
during the wavefield simulation, apply the angle dependent wavefield amplitude correction terms to wavefield amplitudes of the wavefield simulation to enhance seismic energy-based accuracy of the wavefield simulation; and
generate a simulated wavefield as an output of the wavefield simulation.

20. One or more computer-readable storage media comprising computer-executable instructions executable to instruct a computing system to:
receive a seismic model for a geologic region, the seismic model includes an acoustic portion that accounts for wavefield kinematics using one or more acoustic velocity parameters and an elastic portion that accounts for wavefield elastic plane-wave reflectivity using one or more elastic vector reflectivity parameters;
perform a wavefield simulation using the seismic model;
during the wavefield simulation, determine angle dependent wavefield amplitude correction terms, subject to one or more structural dip-based angle criteria, using the elastic portion of the model;
during the wavefield simulation, apply the angle dependent wavefield amplitude correction terms to wavefield amplitudes of the wavefield simulation to enhance seismic energy-based accuracy of the wavefield simulation; and
generate a simulated wavefield as an output of the wavefield simulation.
